(19) United States
(12) Patent Application Publication
(10) Pub. No.: US 2023/0286140 A1
(43) Pub. Date: Sep. 14, 2023

(54) SYSTEMS AND METHODS FOR ROBOTIC SYSTEM WITH OBJECT HANDLING

(71) Applicant: MUJIN, INC., Tokyo (JP)

(72) Inventor: Kei USUI, Tokyo (JP)

(21) Appl. No.: 18/177,578

(22) Filed: Mar. 2, 2023

Related U.S. Application Data
(60) Provisional application No. 63/317,558, filed on Mar. 8, 2022.

(51) Int. Cl. B25J 9/16; B25J 19/02

(52) U.S. Cl. CPC B25J 9/1612; B25J 9/1664; B25J 9/1653; B25J 9/163; B25J 9/1697; B25J 19/023

(57) ABSTRACT

A computing system includes at least one processing circuit in communication with a robot having a robot arm that includes or is attached to an end effector apparatus. A object handling environment including a source of objects for delivery to a destination is provided. The at least one processing circuit identifies a target object amongst the plurality of objects in the source of objects, determines an approach trajectory for the robot arm and end effector apparatus to approach the plurality of objects, determines a grasp operation for grasping the target object with the end effector apparatus, and controls the robot arm and end effector apparatus to traverse the determined trajectories and pick up the target object. The at least one processing circuit determines a destination approach trajectory, and controls the robot arm and end effector apparatus gripping the target object to approach the destination, and release the target object into the destination.

### CROSS-REFERENCE TO RELATED APPLICATION(S)

The present application claims the benefit of U.S. Provisional Appl. No. 63/317,558, entitled “ROBOTIC SYSTEM WITH OBJECT HANDLING” and filed Mar. 8, 2022, the entire contents of which are incorporated by reference herein.

### FIELD OF THE INVENTION

The present technology is directed generally to robotic systems and, more specifically, to systems, processes, and techniques for detecting and handling objects. More particularly, the present technology may be used for detecting and handling objects in containers.

### BACKGROUND

With their ever-increasing performance and lowering cost, many robots (e.g., machines configured to automatically/autonomously execute physical actions) are now extensively used in various different fields. Robots, for example, can be used to execute various tasks (e.g., manipulate or transfer an object through space) in manufacturing and/or assembly, packing and/or packaging, transport and/or shipping, etc. In executing the tasks, the robots can replicate human actions, thereby replacing or reducing human involvements that are otherwise required to perform dangerous or repetitive tasks.

However, despite the technological advancements, robots often lack the sophistication necessary to duplicate human interactions required for executing larger and/or more complex tasks. Accordingly, there remains a need for improved techniques and systems for managing operations and/or interactions between robots.

### BRIEF SUMMARY

In embodiments, a computing system is provided. The computing system includes a control system configured to communicate with a robot having a robot arm that includes or is attached to an end effector apparatus, and to communicate with a camera. At least one processing circuit may be configured, when the robot is in an object handling environment including a source of objects for transfer to a destination within the object handling environment, to perform the following for transferring a target object from the source of objects to the destination: identifying the target object from among a plurality of objects in the source of objects; generating an arm approach trajectory for the robot arm to approach the plurality of objects; generating an end effector apparatus approach trajectory for the end effector apparatus to approach the target object; generating a grasp operation for grasping the target object with the end effector apparatus; outputting an arm approach command to control the robot arm according to the arm approach trajectory to approach the plurality of objects; outputting an end effector apparatus approach command to control the robot arm according to the end effector apparatus approach trajectory to approach the target object; and outputting an end effector apparatus control command to control the end effector apparatus in the grasp operation to grasp the target object.

In another embodiment, a method of picking a target object from a source of objects is provided. The method comprises the steps of: identifying the target object from among a plurality of objects in the source of objects; determining an arm approach trajectory for a robot arm having an end effector apparatus to approach the plurality of objects; generating an end effector apparatus approach trajectory for the end effector apparatus to approach the target object; generating a grasp operation for grasping the target object with the end effector apparatus; outputting an arm approach command to control the robot arm according to the arm approach trajectory to approach the plurality of objects; outputting an end effector apparatus approach command to control the robot arm according to the end effector apparatus approach trajectory to approach the target object; and outputting an end effector apparatus control command to control the end effector apparatus to grasp the object.

In another embodiment, a non-transitory computer readable medium, configured with executable instructions for implementing a method for picking a target object from a source of objects, operable by at least one processing circuit via a communication interface configured to communicate with a robotic system, is provided. The method comprises identifying the target object from among a plurality of objects in the source of objects; generating an arm approach trajectory for a robot arm having an end effector apparatus to approach the plurality of objects; generating an end effect apparatus approach trajectory for the end effector apparatus to approach the target object; generating a grasp operation for grasping the target object with the end effector apparatus; outputting an arm approach command to control the robot arm according to the arm approach trajectory approaching the plurality of objects; outputting an end effector apparatus approach command to control the robot arm according to the end effector apparatus approach trajectory approaching the target object; and outputting an end effector apparatus control command to control the end effector apparatus to grasp the target object.

### BRIEF DESCRIPTION OF THE FIGURES

FIG. 1A illustrates a system for performing or facilitating the detection, identification, and retrieval of objects according to embodiments hereof.

FIG. 1B illustrates an embodiment of the system for performing or facilitating t the detection, identification, and retrieval of objects according to embodiments hereof.

FIG. 1C illustrates another embodiment of the system for performing or facilitating the detection, identification, and retrieval of objects according to embodiments hereof.

FIG. 1D illustrates yet another embodiment of the system for performing or facilitating the detection, identification, and retrieval of objects according to embodiments hereof.

FIG. 2A is a block diagram that illustrates a computing system configured to perform or facilitate the detection, identification, and retrieval of objects, consistent with embodiments hereof.

FIG. 2B is a block diagram that illustrates an embodiment of a computing system configured to perform or facilitate the detection, identification, and retrieval of objects, consistent with embodiments hereof.

FIG. 2C is a block diagram that illustrates another embodiment of a computing system configured to perform or facilitate the detection, identification, and retrieval of objects, consistent with embodiments hereof.

FIG. 2D is a block diagram that illustrates yet another embodiment of a computing system configured to perform or facilitate the detection, identification, and retrieval of objects, consistent with embodiments hereof.

FIG. 2E is an example of image information processed by systems and consistent with embodiments hereof.

FIG. 2F is an example of image information processed by systems and consistent with embodiments hereof.

FIG. 3A illustrates an exemplary environment for operating a robotic system, according to embodiments hereof.

FIG. 3B illustrates an exemplary environment for the detection, identification, and retrieval of objects by a robotic system, consistent with embodiments hereof.

FIG. 3C illustrates a robotic system having an arm, a base, and an end effector apparatus.

FIG. 3D illustrates another exemplary embodiment of a robotic system having an arm, a base, and an end effector apparatus.

FIG. 4 provides a flow diagram illustrating an overall flow of methods and operations for the detection, planning, picking, transferring, and placing of target objects, according to embodiments hereof.

FIG. 5A illustrates a container or source location including a plurality of objects.

FIG. 5B illustrates a visual depiction of the detection result described herein for multiple detected objects from a plurality of objects in a container or source location.

FIG. 5C illustrates an example of object recognition from the detection result consistent with embodiments hereof.

FIGS. 6A-6C illustrate various grasping models utilized by a robotic system for grasping objects.

FIG. 7A illustrates a motion plan for a transfer cycle of an object by a robotic arm from a source to a destination.

FIG. 7B illustrates an embodiment of the systems and methods of object handling via a robotic system as described herein.

FIG. 7C illustrates a visual depiction of the detection result described herein for multiple detected objects from a plurality of objects in a container or source location, with primary objects and secondary objects selected via the operations further described herein.

FIG. 7D illustrates an example of bounding box use via a robotic system during grasp operations as described herein.

FIG. 8A illustrates an end effector apparatus grasp approach trajectory.

FIG. 8B illustrates an object chuck operation.

FIG. 8C illustrates an object grasp depart trajectory.

FIG. 9A illustrates a second object grasp approach trajectory.

FIG. 9B illustrates a second object chuck operation.

FIG. 9C illustrates a second object grasp depart trajectory.

### DETAILED DESCRIPTION

Systems and methods related to object detection, identification, and retrieval are described herein. In particular, the disclosed systems and methods may facilitate object detection, identification, and retrieval where the objects are located in containers. As discussed herein, the objects may be metal or other material and may be located in a source, including containers such as boxes, bins, crates, etc. The objects may be situated in the containers in an unorganized or irregular fashion, for example, a box full of screws. Object detection and identification in such circumstances may be challenging due to the irregular arrangement of the objects, although systems and methods discussed herein may equally improve object detection, identification, and retrieval of objects that are arranged in a regular or semi-regular fashion. Accordingly, systems and methods described herein are designed to identify individual objects from among multiple objects, wherein the individual objects may be arranged in different locations, at different angles, etc. The systems and methods discussed herein may include robotic systems. Robotic systems configured in accordance with embodiments hereof may autonomously execute integrated tasks by coordinating operations of multiple robots. Robotic systems, as described herein, may include any suitable combination of robotic devices, actuators, sensors, cameras, and computing systems configured to control, issue commands, receive information from robotic devices and sensors, access, analyze, and process data generated by robotic devices, sensors, and camera, generate data or information usable in the control of robotic systems, and plan actions for robotic devices, sensors, and cameras. As used herein, robotic systems are not required to have immediate access or control of robotic actuators, sensors, or other devices. Robotic systems, as described here, may be computational systems configured to improve the performance of such robotic actuators, sensors, and other devices through reception, analysis, and processing of information.

The technology described herein provides technical improvements to a robotic system configured for use in object identification, detection, and retrieval. Technical improvements described herein increase the speed, precision, and accuracy of these tasks and further facilitate the detection, identification, and retrieval of objects from a container. The robotic systems and computational systems described herein address the technical problem of identifying, detecting, and retrieving objects from a container, where the objects may be irregularly arranged. By addressing this technical problem, the technology of object identification, detection, and retrieval is improved.

The present application refers to systems and robotic systems. Robotic systems, as discussed herein, may include robotic actuator components (e.g., robotic arms, robotic grippers, etc.), various sensors (e.g., cameras, etc.), and various computing or control systems. As discussed herein, computing systems or control systems may be referred to as “controlling” various robotic components, such as robotic arms, robotic grippers, cameras, etc. Such “control” may refer to direct control of and interaction with the various actuators, sensors, and other functional aspects of the robotic components. For example, a computing system may control a robotic arm by issuing or providing all of the required signals to cause the various motors, actuators, and sensors to cause robotic movement. Such “control” may also refer to the issuance of abstract or indirect commands to a further robotic control system that then translates such commands into the necessary signals for causing robotic movement. For example, a computing system may control a robotic arm by issuing a command describing a trajectory or destination location to which the robotic arm should move to and a further robotic control system associated with the robotic arm may receive and interpret such a command and then provide the necessary direct signals to the various actuators and sensors of the robotic arm to cause the required movement.

In particular, the present technology described herein assists a robotic system to interact with a target object among a plurality of objects in a container. Detection, identification, and retrieval of an object from a container requires several steps, including the generation of suitable object recognition templates, extracting features usable for identification, and generating, refining, and validating detection hypotheses. For example, because of the potential for irregular arrangement of the object, it may be necessary to recognize and identify the object in multiple different poses (e.g., angles and locations) and when potentially obscured by portions of other objects.

In the following, specific details are set forth to provide an understanding of the presently disclosed technology. In embodiments, the techniques introduced here may be practiced without including each specific detail disclosed herein. In other instances, well-known features, such as specific functions or routines, are not described in detail to avoid unnecessarily obscuring the present disclosure. References in this description to “an embodiment,” “one embodiment,” or the like mean that a particular feature, structure, material, or characteristic being described is included in at least one embodiment of the present disclosure. Thus, the appearances of such phrases in this specification do not necessarily all refer to the same embodiment. On the other hand, such references are not necessarily mutually exclusive either. Furthermore, the particular features, structures, materials, or characteristics described with respect to any one embodiments can be combined in any suitable manner with those of any other embodiment, unless such items are mutually exclusive. It is to be understood that the various embodiments shown in the figures are merely illustrative representations and are not necessarily drawn to scale.

Several details describing structures or processes that are well-known and often associated with robotic systems and subsystems, but that can unnecessarily obscure some significant aspects of the disclosed techniques, are not set forth in the following description for purposes of clarity. Moreover, although the following disclosure sets forth several embodiments of different aspects of the present technology, several other embodiments may have different configurations or different components than those described in this section. Accordingly, the disclosed techniques may have other embodiments with additional elements or without several of the elements described below.

Many embodiments or aspects of the present disclosure described below may take the form of computer- or controller-executable instructions, including routines executed by a programmable computer or controller. Those skilled in the relevant art will appreciate that the disclosed techniques can be practiced on or with computer or controller systems other than those shown and described below. The techniques described herein can be embodied in a special-purpose computer or data processor that is specifically programmed, configured, or constructed to execute one or more of the computer-executable instructions described below. Accordingly, the terms “computer” and “controller” as generally used herein refer to any data processor and can include Internet appliances and handheld devices (including palm-top computers, wearable computers, cellular or mobile phones, multi-processor systems, processor-based or programmable consumer electronics, network computers, minicomputers, and the like). Information handled by these computers and controllers can be presented at any suitable display medium, including a liquid crystal display (LCD). Instructions for executing computer- or controller-executable tasks can be stored in or on any suitable computer-readable medium, including hardware, firmware, or a combination of hardware and firmware. Instructions can be contained in any suitable memory device, including, for example, a flash drive, USB device, and/or other suitable medium.

The terms “coupled” and “connected,” along with their derivatives, can be used herein to describe structural relationships between components. It should be understood that these terms are not intended as synonyms for each other. Rather, in particular embodiments, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements co-operate or interact with each other (e.g., as in a cause-and-effect relationship, such as for signal transmission/reception or for function calls), or both.

Any reference herein to image analysis by a computing system may be performed according to or using spatial structure information that may include depth information which describes respective depth value of various locations relative a chosen point. The depth information may be used to identify objects or estimate how objects are spatially arranged. In some instances, the spatial structure information may include or may be used to generate a point cloud that describes locations of one or more surfaces of an object. Spatial structure information is merely one form of possible image analysis and other forms known by one skilled in the art may be used in accordance with the methods described herein.

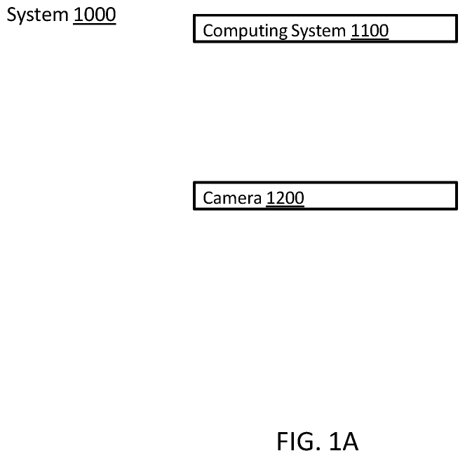

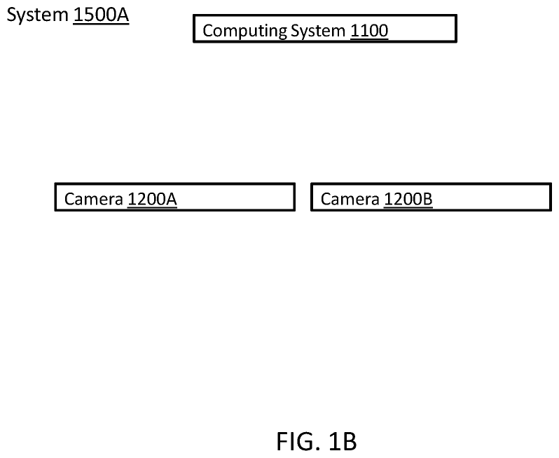

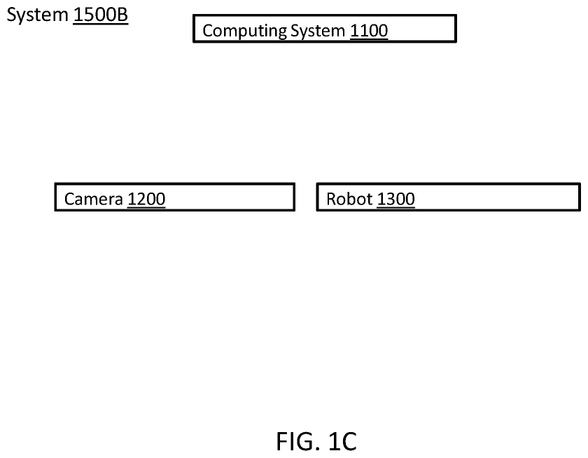

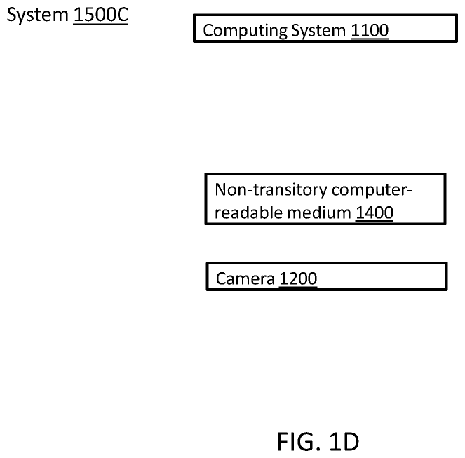

FIG. 1A illustrates a system 1000 for performing object detection, or, more specifically, object recognition. More particularly, the system 1000 may include a computing system 1100 and a camera 1200. In this example, the camera 1200 may be configured to generate image information which describes or otherwise represents an environment in which the camera 1200 is located, or, more specifically, represents an environment in the camera's 1200 field of view (also referred to as a camera field of view). The environment may be, e.g., a warehouse, a manufacturing plant, a retail space, or other premises. In such instances, the image information may represent objects located at such premises, such as boxes, bins, cases, crates, pallets, or other containers. The system 1000 may be configured to generate, receive, and/or process the image information, such as by using the image information to distinguish between individual objects in the camera field of view, to perform object recognition or object registration based on the image information, and/or perform robot interaction planning based on the image information, as discussed below in more detail (the terms “and/or” and “or” are used interchangeably in this disclosure). The robot interaction planning may be used to, e.g., control a robot at the premises to facilitate robot interaction between the robot and the containers or other objects. The computing system 1100 and the camera 1200 may be located at the same premises or may be located remotely from each other. For instance, the computing system 1100 may be part of a cloud computing platform hosted in a data center which is remote from the warehouse or retail space and may be communicating with the camera 1200 via a network connection.

In embodiments, the camera 1200 (which may also be referred to as an image sensing device) may be a 2D camera and/or a 3D camera. For example, FIG. 1B illustrates a system 1500A (which may be an embodiment of the system 1000) that includes the computing system 1100 as well as a camera 1200A and a camera 1200B, both of which may be an embodiment of the camera 1200. In this example, the camera 1200A may be a 2D camera that is configured to generate 2D image information which includes or forms a 2D image that describes a visual appearance of the environment in the camera's field of view. The camera 1200B may be a 3D camera (also referred to as a spatial structure sensing camera or spatial structure sensing device) that is configured to generate 3D image information which includes or forms spatial structure information regarding an environment in the camera's field of view. The spatial structure information may include depth information (e.g., a depth map) which describes respective depth values of various locations relative to the camera 1200B, such as locations on surfaces of various objects in the camera 1200B's field of view. These locations in the camera's field of view or on an object's surface may also be referred to as physical locations. The depth information in this example may be used to estimate how the objects are spatially arranged in three-dimensional (3D) space. In some instances, the spatial structure information may include or may be used to generate a point cloud that describes locations on one or more surfaces of an object in the camera 1200B's field of view. More specifically, the spatial structure information may describe various locations on a structure of the object (also referred to as an object structure).

In embodiments, the system 1000 may be a robot operation system for facilitating robot interaction between a robot and various objects in the environment of the camera 1200. For example, FIG. 1C illustrates a robot operation system 1500B, which may be an embodiment of the system 1000/1500A of FIGS. 1A and 1B. The robot operation system 1500B may include the computing system 1100, the camera 1200, and a robot 1300. As stated above, the robot 1300 may be used to interact with one or more objects in the environment of the camera 1200, such as with boxes, crates, bins, pallets, or other containers. For example, the robot 1300 may be configured to pick up the containers from one location and move them to another location. In some cases, the robot 1300 may be used to perform a de-palletization operation in which a group of containers or other objects are unloaded and moved to, e.g., a conveyor belt. In some implementations, the camera 1200 may be attached to the robot 1300 or the robot 3300, discussed below. This is also known as a camera in-hand or a camera on-hand solution. The camera 1200 may be attached to a robot arm 3320 of the robot 1300. The robot arm 3320 may then move to various picking regions to generate image information regarding those regions. In some implementations, the camera 1200 may be separate from the robot 1300. For instance, the camera 1200 may be mounted to a ceiling of a warehouse or other structure and may remain stationary relative to the structure. In some implementations, multiple cameras 1200 may be used, including multiple cameras 1200 separate from the robot 1300 and/or cameras 1200 separate from the robot 1300 being used in conjunction with in-hand cameras 1200. In some implementations, a camera 1200 or cameras 1200 may be mounted or affixed to a dedicate robotic system separate from the robot 1300 used for object manipulation, such as a robotic arm, gantry, or other automated system configured for camera movement. Throughout the specification, “control” or “controlling” the camera 1200 may be discussed. For camera in-hand solutions, control of the camera 1200 also includes control of the robot 1300 to which the camera 1200 is mounted or attached.

In embodiments, the computing system 1100 of FIGS. 1A-1C may form or be integrated into the robot 1300, which may also be referred to as a robot controller. A robot control system may be included in the system 1500B, and is configured to e.g., generate commands for the robot 1300, such as a robot interaction movement command for controlling robot interaction between the robot 1300 and a container or other object. In such an embodiment, the computing system 1100 may be configured to generate such commands based on, e.g., image information generated by the camera 1200. For instance, the computing system 1100 may be configured to determine a motion plan based on the image information, wherein the motion plan may be intended for, e.g., gripping or otherwise grasping an object. The computing system 1100 may generate one or more robot interaction movement commands to execute the motion plan.

In embodiments, the computing system 1100 may form or be part of a vision system. The vision system may be a system which generates, e.g., vision information which describes an environment in which the robot 1300 is located, or, alternatively or in addition to, describes an environment in which the camera 1200 is located. The vision information may include the 3D image information and/or the 2D image information discussed above, or some other image information. In some scenarios, if the computing system 1100 forms a vision system, the vision system may be part of the robot control system discussed above or may be separate from the robot control system. If the vision system is separate from the robot control system, the vision system may be configured to output information describing the environment in which the robot 1300 is located. The information may be outputted to the robot control system, which may receive such information from the vision system and performs motion planning and/or generates robot interaction movement commands based on the information. Further information regarding the vision system is detailed below.

In embodiments, the computing system 1100 may communicate with the camera 1200 and/or with the robot 1300 via a direct connection, such as a connection provided via a dedicated wired communication interface, such as a RS-232 interface, a universal serial bus (USB) interface, and/or via a local computer bus, such as a peripheral component interconnect (PCI) bus. In embodiments, the computing system 1100 may communicate with the camera 1200 and/or with the robot 1300 via a network. The network may be any type and/or form of network, such as a personal area network (PAN), a local-area network (LAN), e.g., Intranet, a metropolitan area network (MAN), a wide area network (WAN), or the Internet. The network may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol.

In embodiments, the computing system 1100 may communicate information directly with the camera 1200 and/or with the robot 1300, or may communicate via an intermediate storage device, or more generally an intermediate non-transitory computer-readable medium. For example, FIG. 1D illustrates a system 1500C, which may be an embodiment of the system 1000/1500A/1500B, that includes a non-transitory computer-readable medium 1400, which may be external to the computing system 1100, and may act as an external buffer or repository for storing, e.g., image information generated by the camera 1200. In such an example, the computing system 1100 may retrieve or otherwise receive the image information from the non-transitory computer-readable medium 1400. Examples of the non-transitory computer readable medium 1400 include an electronic storage device, a magnetic storage device, an optical storage device, an electromagnetic storage device, a semiconductor storage device, or any suitable combination thereof. The non-transitory computer-readable medium may form, e.g., a computer diskette, a hard disk drive (HDD), a solid-state drive (SDD), a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), and/or a memory stick.

As stated above, the camera 1200 may be a 3D camera and/or a 2D camera. The 2D camera may be configured to generate a 2D image, such as a color image or a grayscale image. The 3D camera may be, e.g., a depth-sensing camera, such as a time-of-flight (TOF) camera or a structured light camera, or any other type of 3D camera. In some cases, the 2D camera and/or 3D camera may include an image sensor, such as a charge coupled devices (CCDs) sensor and/or complementary metal oxide semiconductors (CMOS) sensor. In embodiments, the 3D camera may include lasers, a LIDAR device, an infrared device, a light/dark sensor, a motion sensor, a microwave detector, an ultrasonic detector, a RADAR detector, or any other device configured to capture depth information or other spatial structure information.

As stated above, the image information may be processed by the computing system 1100. In embodiments, the computing system 1100 may include or be configured as a server (e.g., having one or more server blades, processors, etc.), a personal computer (e.g., a desktop computer, a laptop computer, etc.), a smartphone, a tablet computing device, and/or other any other computing system. In embodiments, any or all of the functionality of the computing system 1100 may be performed as part of a cloud computing platform. The computing system 1100 may be a single computing device (e.g., a desktop computer), or may include multiple computing devices.

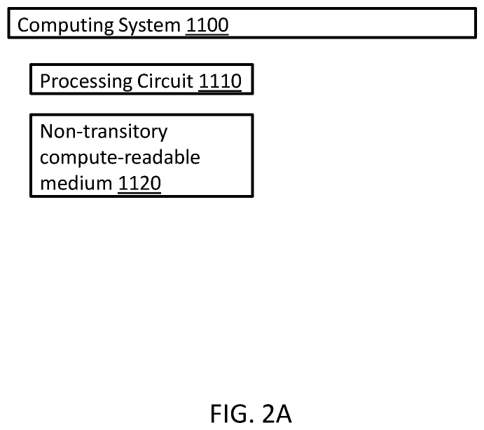

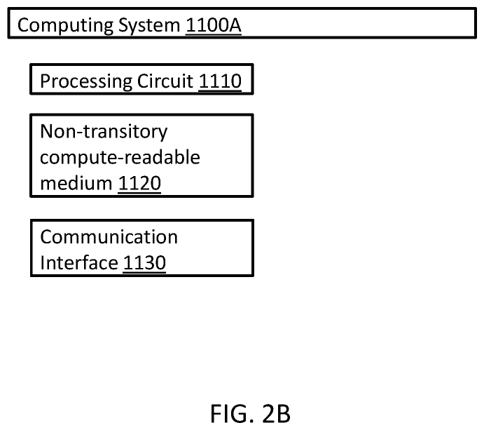

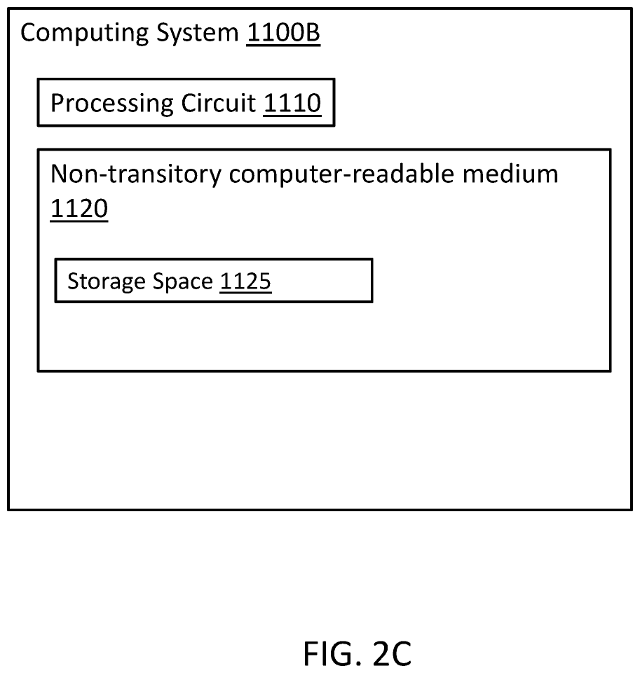

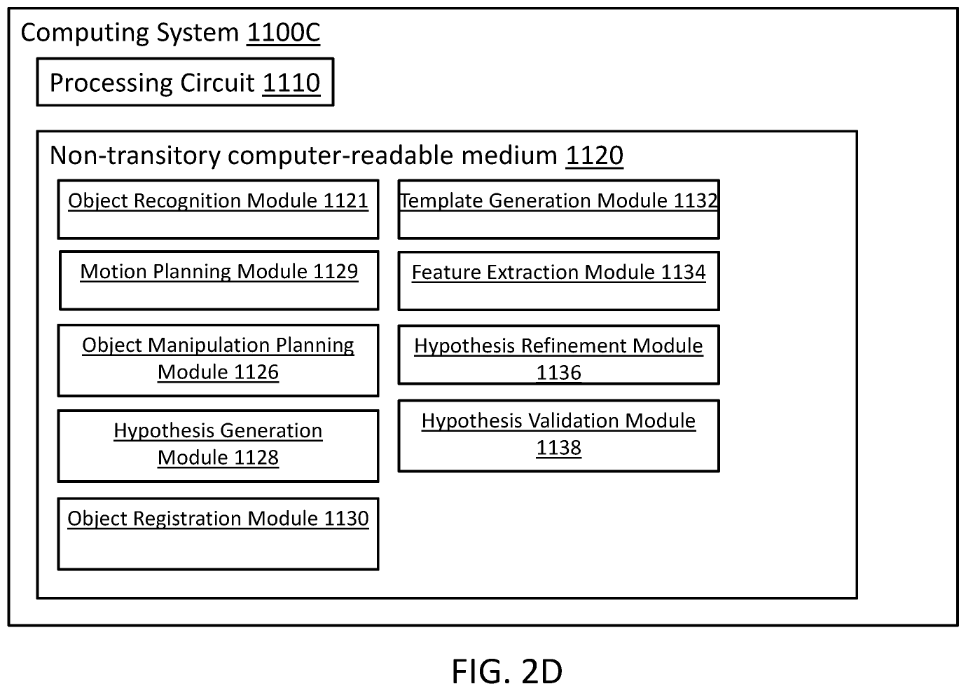

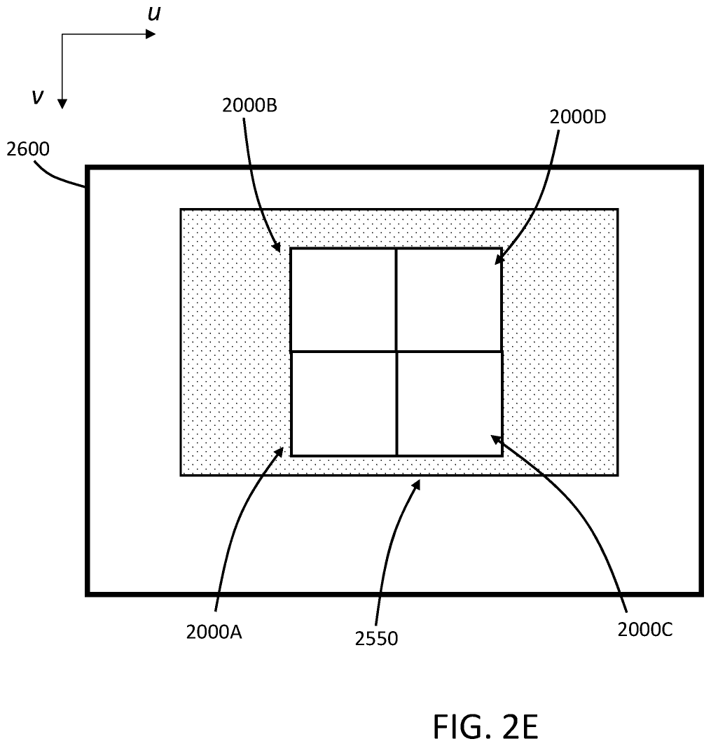

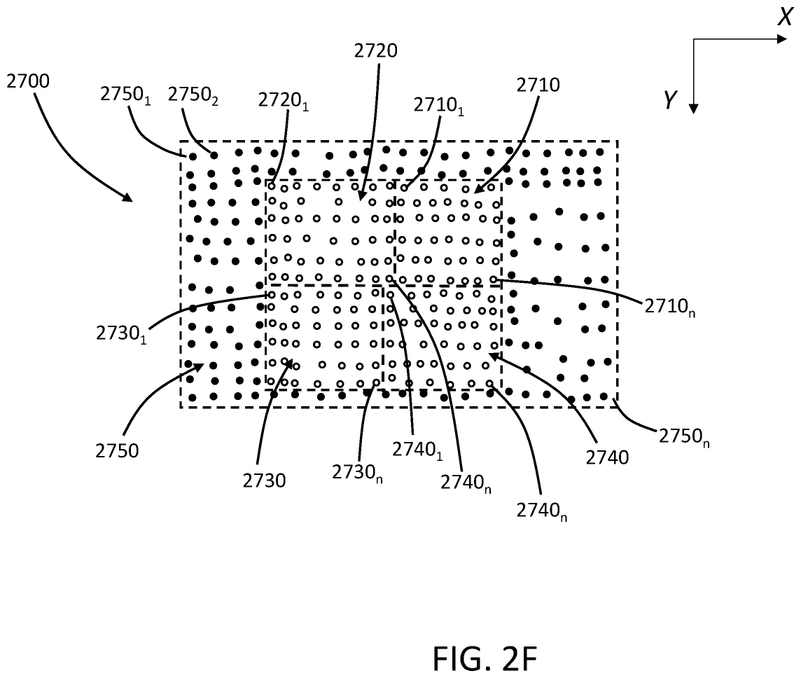

FIG. 2A provides a block diagram that illustrates an embodiment of the computing system 1100. The computing system 1100 in this embodiment includes at least one processing circuit 1110 and a non-transitory computer-readable medium (or media) 1120. In some instances, the processing circuit 1110 may include processors (e.g., central processing units (CPUs), special-purpose computers, and/or onboard servers) configured to execute instructions (e.g., software instructions) stored on the non-transitory computer-readable medium 1120 (e.g., computer memory). In some embodiments, the processors may be included in a separate/stand-alone controller that is operably coupled to the other electronic/electrical devices. The processors may implement the program instructions to control/interface with other devices, thereby causing the computing system 1100 to execute actions, tasks, and/or operations. In embodiments, the processing circuit 1110 includes one or more processors, one or more processing cores, a programmable logic controller (“PLC”), an application specific integrated circuit (“ASIC”), a programmable gate array (“PGA”), a field programmable gate array (“FPGA”), any combination thereof, or any other processing circuit.

In embodiments, the non-transitory computer-readable medium 1120, which is part of the computing system 1100, may be an alternative or addition to the intermediate non-transitory computer-readable medium 1400 discussed above. The non-transitory computer-readable medium 1120 may be a storage device, such as an electronic storage device, a magnetic storage device, an optical storage device, an electromagnetic storage device, a semiconductor storage device, or any suitable combination thereof, for example, such as a computer diskette, a hard disk drive (HDD), a solid state drive (SSD), a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, any combination thereof, or any other storage device. In some instances, the non-transitory computer-readable medium 1120 may include multiple storage devices. In certain implementations, the non-transitory computer-readable medium 1120 is configured to store image information generated by the camera 1200 and received by the computing system 1100. In some instances, the non-transitory computer-readable medium 1120 may store one or more object recognition template used for performing methods and operations discussed herein. The non-transitory computer-readable medium 1120 may alternatively or additionally store computer readable program instructions that, when executed by the processing circuit 1110, causes the processing circuit 1110 to perform one or more methodologies described here.

FIG. 2B depicts a computing system 1100A that is an embodiment of the computing system 1100 and includes a communication interface 1131. The communication interface 1131 may be configured to, e.g., receive image information generated by the camera 1200 of FIGS. 1A-1D. The image information may be received via the intermediate non-transitory computer-readable medium 1400 or the network discussed above, or via a more direct connection between the camera 1200 and the computing system 1100/1100A. In embodiments, the communication interface 1131 may be configured to communicate with the robot 1300 of FIG. 1C. If the computing system 1100 is external to a robot control system, the communication interface 1131 of the computing system 1100 may be configured to communicate with the robot control system. The communication interface 1131 may also be referred to as a communication component or communication circuit, and may include, e.g., a communication circuit configured to perform communication over a wired or wireless protocol. As an example, the communication circuit may include a RS-232 port controller, a USB controller, an Ethernet controller, a Bluetooth® controller, a PCI bus controller, any other communication circuit, or a combination thereof.

In embodiments, as depicted in FIG. 2C, the non-transitory computer-readable medium 1120 may include a storage space 1125 configured to store one or more data objects discussed herein. For example, the storage space may store object recognition templates, detection hypotheses, image information, object image information, robotic arm move commands, and any additional data objects the computing systems discussed herein may require access to.

In embodiments, the processing circuit 1110 may be programmed by one or more computer-readable program instructions stored on the non-transitory computer-readable medium 1120. For example, FIG. 2D illustrates a computing system 1100C, which is an embodiment of the computing system 1100/1100A/1100B, in which the processing circuit 1110 is programmed by one or more modules, including an object recognition module 1121, a motion planning module 1129, and an object manipulation planning module 1126. The processing circuit 1110 may further be programmed with a hypothesis generation module 1128, an object registration module 1130, a template generation module 1132, a feature extraction module 1134, a hypothesis refinement module 1136, and a hypothesis validation module 1138. Each of the above modules may represent computer-readable program instructions configured to carry out certain tasks when instantiated on one or more of the processors, processing circuits, computing systems, etc., described herein. Each of the above module may operate in concert with one another to achieve the functionality described herein. Various aspects of the functionality described herein may be carried out by one or more of the software modules described above and the software modules and their descriptions are not to be understood as limiting the computational structure of systems disclosed herein. For example, although a specific task or functionality may be described with respect to a specific module, that task or functionality may also be performed by a different module as required. Further, the system functionality described herein may be performed by a different set of software modules configured with a different breakdown or allotment of functionality.

In embodiments, the object recognition module 1121 may be configured to obtain and analyze image information as discussed throughout the disclosure. Methods, systems, and techniques discussed herein with respect to image information may use the object recognition module 1121. The object recognition module may further be configured for object recognition tasks related to object identification, as discussed herein.

The motion planning module 1129 may be configured plan and execute the movement of a robot. For example, the motion planning module 1129 may interact with other modules described herein to plan motion of a robot 3300 for object retrieval operations and for camera placement operations. Methods, systems, and techniques discussed herein with respect to robotic arm movements and trajectories may be performed by the motion planning module 1129.

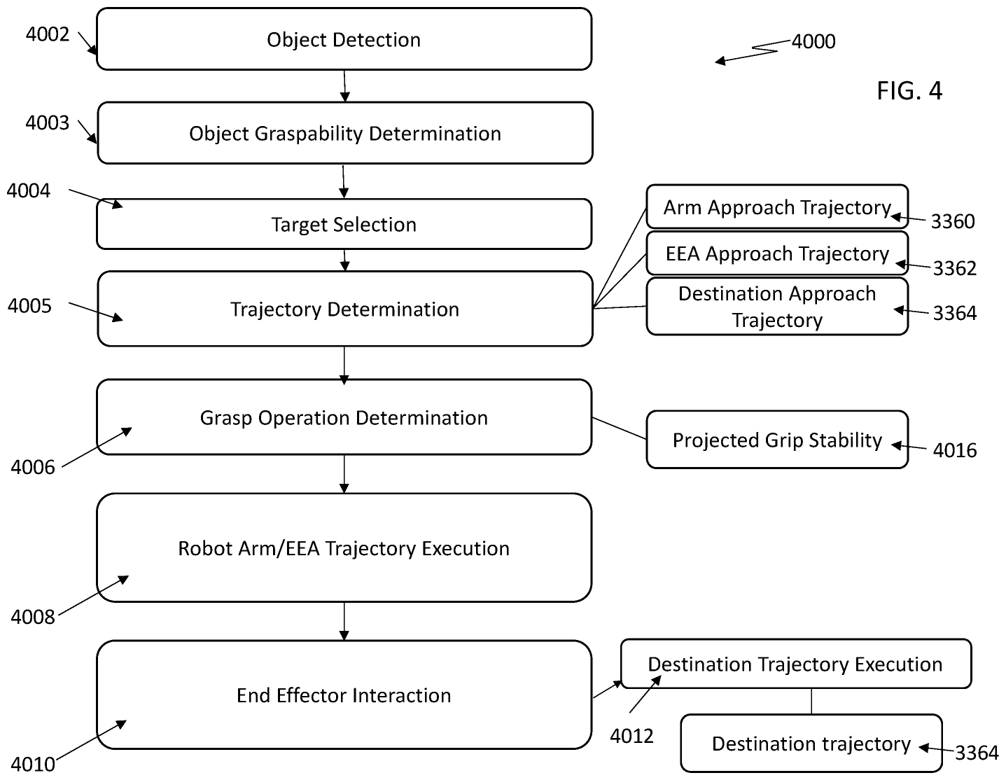

The object manipulation planning module 1126 may be configured to plan and execute the object manipulation activities of a robotic arm, e.g., grasping and releasing objects and executing robotic arm commands to aid and facilitate such grasping and releasing. The object manipulation planning module 1126 may be configured to perform processing related to trajectory determination, picking and gripping procedure determination, and end effector interaction with objects. Operations of the object manipulation planning module 1126 are described in further detail with respect to FIG. 4.

The hypothesis generation module 1128 may be configured to perform template matching and recognition tasks to generate a detection hypothesis. The hypothesis generation module 1128 may be configured to interact or communicate with any other necessary module.

The object registration module 1130 may be configured to obtain, store, generate, and otherwise process object registration information that may be required for various tasks discussed herein. The object registration module 1130 may be configured to interact or communicate with any other necessary module.

The template generation module 1132 may be configured to complete object recognition template generation tasks. The template generation module 1132 may be configured to interact with the object registration module 1130, the feature extraction module 1134, and any other necessary module.

The feature extraction module 1134 may be configured to complete feature extraction and generation tasks. The feature extraction module 1134 may be configured to interact with the object registration module 1130, the template generation module 1132, the hypothesis generation module 1128, and any other necessary module.

The hypothesis refinement module 1136 may be configured to complete hypothesis refinement tasks. The hypothesis refinement module 1136 may be configured to interact with the object recognition module 1121 and the hypothesis generation module 1128, and any other necessary module.

The hypothesis validation module 1138 may be configured to complete hypothesis validation tasks. The hypothesis validation module 1138 may be configured to interact with the object registration module 1130, the feature extraction module 1134, the hypothesis generation module 1128, the hypothesis refinement module 1136, and any other necessary modules.

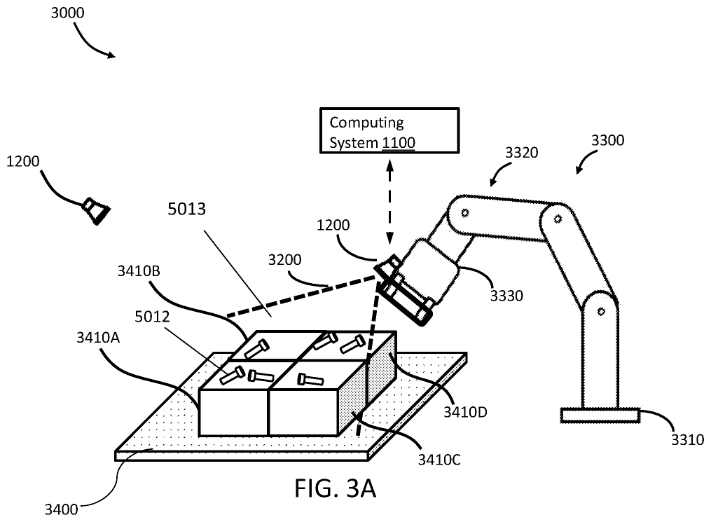

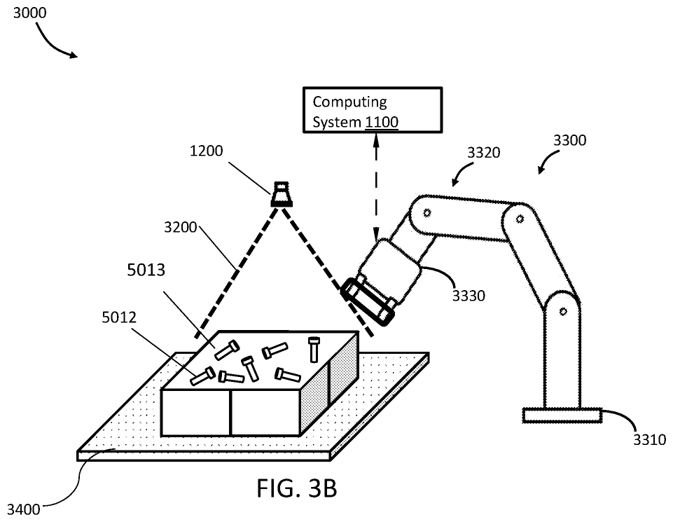

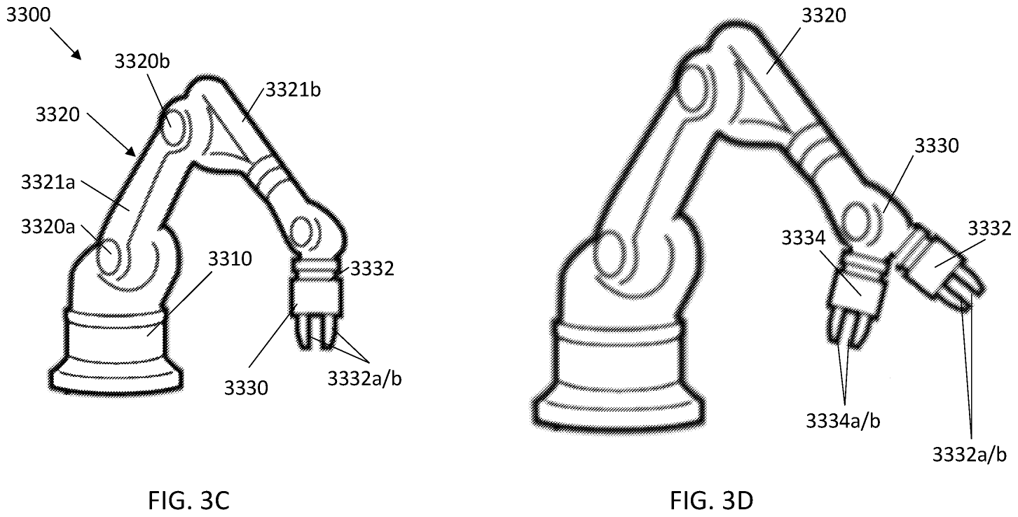

With reference to FIGS. 2E, 2F, 3A, and 3B, methods related to the object recognition module 1121 that may be performed for image analysis are explained. FIGS. 2E and 2F illustrate example image information associated with image analysis methods while FIGS. 3A and 3B illustrate example robotic environments associated with image analysis methods. References herein related to image analysis by a computing system may be performed according to or using spatial structure information that may include depth information which describes respective depth value of various locations relative a chosen point. The depth information may be used to identify objects or estimate how objects are spatially arranged. In some instances, the spatial structure information may include or may be used to generate a point cloud that describes locations of one or more surfaces of an object. Spatial structure information is merely one form of possible image analysis and other forms known by one skilled in the art may be used in accordance with the methods described herein.

In embodiments, the computing system 1100 may obtain image information representing an object in a camera field of view (e.g., 3200) of a camera 1200. The steps and techniques described below for obtaining image information may be referred to below as an image information capture operation 3001. In some instances, the object may be one object 5012 from a plurality of objects 5012 in a scene 5013 in the field of view 3200 of a camera 1200. The image information 2600, 2700 may be generated by the camera (e.g., 1200) when the objects 5012 are (or have been) in the camera field of view 3200 and may describe one or more of the individual objects 5012 or the scene 5013. The object appearance describes the appearance of an object 5012 from the viewpoint of the camera 1200. If there are multiple objects 5012 in the camera field of view, the camera may generate image information that represents the multiple objects or a single object (such image information related to a single object may be referred to as object image information), as necessary. The image information may be generated by the camera (e.g., 1200) when the group of objects is (or has been) in the camera field of view, and may include, e.g., 2D image information and/or 3D image information.

As an example, FIG. 2E depicts a first set of image information, or more specifically, 2D image information 2600, which, as stated above, is generated by the camera 1200 and represents the objects 3410A/3410B/3410C/3410D/3401 of FIG. 3A. More specifically, the 2D image information 2600 may be a grayscale or color image and may describe an appearance of the objects 3410A/3410B/3410C/3410D/3401 from a viewpoint of the camera 1200. In embodiments, the 2D image information 2600 may correspond to a single-color channel (e.g., red, green, or blue color channel) of a color image. If the camera 1200 is disposed above the objects 3410A/3410B/3410C/3410D/3401, then the 2D image information 2600 may represent an appearance of respective top surfaces of the objects 3410A/3410B/3410C/3410D/3401. In the example of FIG. 2E, the 2D image information 2600 may include respective portions 2000A/2000B/2000C/2000D/2550, also referred to as image portions or object image information, that represent respective surfaces of the objects 3410A/3410B/341C/3410D/3401. In FIG. 2E, each image portion 2000A/2000B/2000C/2000D/2550 of the 2D image information 2600 may be an image region, or more specifically a pixel region (if the image is formed by pixels). Each pixel in the pixel region of the 2D image information 2600 may be characterized as having a position that is described by a set of coordinates [U, V] and may have values that are relative to a camera coordinate system, or some other coordinate system, as shown in FIGS. 2E and 2F. Each of the pixels may also have an intensity value, such as a value between 0 and 255 or 0 and 1023. In further embodiments, each of the pixels may include any additional information associated with pixels in various formats (e.g., hue, saturation, intensity, CMYK, RGB, etc.)

As stated above, the image information may in some embodiments be all or a portion of an image, such as the 2D image information 2600. In examples, the computing system 1100 may be configured to extract an image portion 2000A from the 2D image information 2600 to obtain only the image information associated with a corresponding object 3410A. Where an image portion (such as image portion 2000A) is directed towards a single object it may be referred to as object image information. Object image information is not required to contain information only about an object to which it is directed. For example, the object to which it is directed may be close to, under, over, or otherwise situated in the vicinity of one or more other objects. In such cases, the object image information may include information about the object to which it is directed as well as to one or more neighboring objects. The computing system 1100 may extract the image portion 2000A by performing an image segmentation or other analysis or processing operation based on the 2D image information 2600 and/or 3D image information 2700 illustrated in FIG. 2F. In some implementations, an image segmentation or other processing operation may include detecting image locations at which physical edges of objects appear (e.g., edges of the object) in the 2D image information 2600 and using such image locations to identify object image information that is limited to representing an individual object in a camera field of view (e.g., 3200) and substantially excluding other objects. By “substantially excluding,” it is meant that the image segmentation or other processing techniques are designed and configured to exclude non-target objects from the object image information but that it is understood that errors may be made, noise may be present, and various other factors may result in the inclusion of portions of other objects.

FIG. 2F depicts an example in which the image information is 3D image information 2700. More particularly, the 3D image information 2700 may include, e.g., a depth map or a point cloud that indicates respective depth values of various locations on one or more surfaces (e.g., top surface or other outer surface) of the objects 3410A/3410B/3410C/3410D/3401. In some implementations, an image segmentation operation for extracting image information may involve detecting image locations at which physical edges of objects appear (e.g., edges of a box) in the 3D image information 2700 and using such image locations to identify an image portion (e.g., 2730) that is limited to representing an individual object in a camera field of view (e.g., 3410A).

The respective depth values may be relative to the camera 1200 which generates the 3D image information 2700 or may be relative to some other reference point. In some embodiments, the 3D image information 2700 may include a point cloud which includes respective coordinates for various locations on structures of objects in the camera field of view (e.g., 3200). In the example of FIG. 2F, the point cloud may include respective sets of coordinates that describe the location of the respective surfaces of the objects 3410A/3410B/3410C/3410D/3401. The coordinates may be 3D coordinates, such as [X Y Z] coordinates, and may have values that are relative to a camera coordinate system, or some other coordinate system. For instance, the 3D image information 2700 may include a first image portion 2710, also referred to as an image portion, that indicates respective depth values for a set of locations 2710₁-2710ₙ, which are also referred to as physical locations on a surface of the object 3410D. Further, the 3D image information 2700 may further include a second, a third, a fourth, and a fifth portion 2720, 2730, 2740, and 2750. These portions may then further indicate respective depth values for a set of locations, which may be represented by 2720₁-2720ₙ, 2730₁-2730ₙ, 2740₁-2740ₙ, and 2750₁-2750ₙ respectively. These figures are merely examples, and any number of objects with corresponding image portions may be used. Similarly to as stated above, the 3D image information 2700 obtained may in some instances be a portion of a first set of 3D image information 2700 generated by the camera. In the example of FIG. 2E, if the 3D image information 2700 obtained represents an object 3410A of FIG. 3A, then the 3D image information 2700 may be narrowed as to refer to only the image portion 2710. Similar to the discussion of 2D image information 2600, an identified image portion 2710 may pertain to an individual object and may be referred to as object image information. Thus, object image information, as used herein, may include 2D and/or 3D image information.

In embodiments, an image normalization operation may be performed by the computing system 1100 as part of obtaining the image information. The image normalization operation may involve transforming an image or an image portion generated by the camera 1200, so as to generate a transformed image or transformed image portion. For example, if the image information, which may include the 2D image information 2600, the 3D image information 2700, or a combination of the two, obtained may undergo an image normalization operation to attempt to cause the image information to be altered in viewpoint, object pose, lighting condition associated with the visual description information. Such normalizations may be performed to facilitate a more accurate comparison between the image information and model (e.g., template) information. The viewpoint may refer to a pose of an object relative to the camera 1200, and/or an angle at which the camera 1200 is viewing the object when the camera 1200 generates an image representing the object.

For example, the image information may be generated during an object recognition operation in which a target object is in the camera field of view 3200. The camera 1200 may generate image information that represents the target object when the target object has a specific pose relative to the camera. For instance, the target object may have a pose which causes its top surface to be perpendicular to an optical axis of the camera 1200. In such an example, the image information generated by the camera 1200 may represent a specific viewpoint, such as a top view of the target object. In some instances, when the camera 1200 is generating the image information during the object recognition operation, the image information may be generated with a particular lighting condition, such as a lighting intensity. In such instances, the image information may represent a particular lighting intensity, lighting color, or other lighting condition.

In embodiments, the image normalization operation may involve adjusting an image or an image portion of a scene generated by the camera, so as to cause the image or image portion to better match a viewpoint and/or lighting condition associated with information of an object recognition template. The adjustment may involve transforming the image or image portion to generate a transformed image which matches at least one of an object pose or a lighting condition associated with the visual description information of the object recognition template.

The viewpoint adjustment may involve processing, warping, and/or shifting of the image of the scene so that the image represents the same viewpoint as visual description information that may be included within an object recognition template. Processing, for example, may include altering the color, contrast, or lighting of the image, warping of the scene may include changing the size, dimensions, or proportions of the image, and shifting of the image may include changing the position, orientation, or rotation of the image. In an example embodiment, processing, warping, and or/shifting may be used to alter an object in the image of the scene to have an orientation and/or a size which matches or better corresponds to the visual description information of the object recognition template. If the object recognition template describes a head-on view (e.g., top view) of some object, the image of the scene may be warped so as to also represent a head-on view of an object in the scene.

Further aspects of the object recognition methods performed herein are described in greater detail in U.S. application Ser. No. 16/991,510, filed Aug. 12, 2020, and U.S. application Ser. No. 16/991,466, filed Aug. 12, 2020, each of which is incorporated herein by reference.

In various embodiments, the terms “computer-readable instructions” and “computer-readable program instructions” are used to describe software instructions or computer code configured to carry out various tasks and operations. In various embodiments, the term “module” refers broadly to a collection of software instructions or code configured to cause the processing circuit 1110 to perform one or more functional tasks. The modules and computer-readable instructions may be described as performing various operations or tasks when a processing circuit or other hardware component is executing the modules or computer-readable instructions.

FIGS. 3A-3B illustrate exemplary environments in which the computer-readable program instructions stored on the non-transitory computer-readable medium 1120 are utilized via the computing system 1100 to increase efficiency of object identification, detection, and retrieval operations and methods. The image information obtained by the computing system 1100 and exemplified in FIG. 3A influences the system's decision-making procedures and command outputs to a robot 3300 present within an object environment.

FIGS. 3A-3B illustrate an example environment in which the process and methods described herein may be performed. FIG. 3A depicts an environment having a system 3000 (which may be an embodiment of the system 1000/1500A/1500B/1500C of FIGS. 1A-1D) that includes at least the computing system 1100, a robot 3300, and a camera 1200. The camera 1200 may be an embodiment of the camera 1200 and may be configured to generate image information which represents a scene 5013 in a camera field of view 3200 of the camera 1200, or more specifically represents objects (such as boxes) in the camera field of view 3200, such as objects 3000A, 3000B, 3000C, and 3000D. In one example, each of the objects 3000A-3000D may be, e.g., a container such as a box or crate, while the object 3550 may be, e.g., a pallet on which the containers are disposed. Further, each of the objects 3000A-3000D may further be containers containing individual objects 5012. Each object 5012 may, for example, be a rod, bar, gear, bolt, nut, screw, nail, rivet, spring, linkage, cog, or any other type of physical object, as well as assemblies of multiple objects. FIG. 3A illustrates an embodiment including multiple containers of objects 5012 while FIG. 3B illustrates an embodiment including a single container of objects 5012.

In embodiments, the system 3000 of FIG. 3A may include one or more light sources. The light source may be, e.g., a light emitting diode (LED), a halogen lamp, or any other light source, and may be configured to emit visible light, infrared radiation, or any other form of light toward surfaces of the objects 3000A-3000D. In some implementations, the computing system 1100 may be configured to communicate with the light source to control when the light source is activated. In other implementations, the light source may operate independently of the computing system 1100.

In embodiments, the system 3000 may include a camera 1200 or multiple cameras 1200, including a 2D camera that is configured to generate 2D image information 2600 and a 3D camera that is configured to generate 3D image information 2700. The camera 1200 or cameras 1200 may be mounted or affixed to the robot 3300, may be stationary within the environment, and/or may be affixed to a dedicated robotic system separate from the robot 3300 used for object manipulation, such as a robotic arm, gantry, or other automated system configured for camera movement. FIG. 3A shows an example having a stationary camera 1200 and an in-hand camera 1200, while FIG. 3B shows an example having only a stationary camera 1200. The 2D image information 2600 (e.g., a color image or a grayscale image) may describe an appearance of one or more objects, such as the objects 3000A/3000B/3000C/3000D or the object 5012 in the camera field of view 3200. For instance, the 2D image information 2600 may capture or otherwise represent visual detail disposed on respective outer surfaces (e.g., top surfaces) of the objects 3000A/3000B/3000C/3000D and 5012, and/or contours of those outer surfaces. In embodiments, the 3D image information 2700 may describe a structure of one or more of the objects 3000A/3000B/3000C/3000D/3550 and 5012, wherein the structure for an object may also be referred to as an object structure or physical structure for the object. For example, the 3D image information 2700 may include a depth map, or more generally include depth information, which may describe respective depth values of various locations in the camera field of view 3200 relative to the camera 1200 or relative to some other reference point. The locations corresponding to the respective depth values may be locations (also referred to as physical locations) on various surfaces in the camera field of view 3200, such as locations on respective top surfaces of the objects 3000A/3000B/3000C/3000D/3550 and 5012. In some instances, the 3D image information 2700 may include a point cloud, which may include a plurality of 3D coordinates that describe various locations on one or more outer surfaces of the objects 3000A/3000B/3000C/3000D/3550 and 5012, or of some other objects in the camera field of view 3200. The point cloud is shown in FIG. 2F.

In the example of FIGS. 3A and 3B, the robot 3300 (which may be an embodiment of the robot 1300) may include a robot arm 3320 having one end attached to a robot base 3310 and having another end that is attached to or is formed by an end effector apparatus 3330, such as a robot gripper. The robot base 3310 may be used for mounting the robot arm 3320, while the robot arm 3320, or more specifically the end effector apparatus 3330, may be used to interact with one or more objects in an environment of the robot 3300. The interaction (also referred to as robot interaction) may include, e.g., gripping or otherwise grasping at least one of the objects 3000A-3000D and 5012. For example, the robot interaction may be part of an object picking operation to identify, detect, and retrieve the objects 5012 from containers. The end effector apparatus 3330 may have suction cups or other components for grasping or grabbing the object 5012. The end effector apparatus 3330 may be configured, using a suction cup or other grasping component, to grasp or grab an object through contact with a single face or surface of the object, for example, via a top face.

The robot 3300 may further include additional sensors configured to obtain information used to implement the tasks, such as for manipulating the structural members and/or for transporting the robotic units. The sensors can include devices configured to detect or measure one or more physical properties of the robot 3300 (e.g., a state, a condition, and/or a location of one or more structural members/joints thereof) and/or of a surrounding environment. Some examples of the sensors can include accelerometers, gyroscopes, force sensors, strain gauges, tactile sensors, torque sensors, position encoders, etc.

In embodiments, a computing system 1100 comprises a control system configured to communicate with the robot 3300 having a robot arm 3320 that includes or is attached to an end effector apparatus 3330, and having a camera 1200 attached to the robot arm 3320. FIGS. 3C-3D illustrate embodiments of a robot 3300 with which the computing system 1100 may communicate with and command/control to achieve the methods described herein. In embodiments, the camera 1200 is disposed elsewhere in an object handling environment 3400, while in communication with the control system of the computing system 1100 either via wireless or hard wired connection. The robot 3300 may include physical or structural members 3321a, 3321b that are connected at joints 3320a, 3320b to form the robot arm 3320 and end effector apparatus 3330 and allow for a greater range of motion (e.g., rotational and/or translational displacements). The physical or structural members 3321a may further connect to the robot base 3310 via the joints 3320a. The robot 3300 may include actuation devices such as motors, actuators, wires, artificial muscles, electroactive polymers, etc. (not shown) configured to drive or manipulate (e.g., displace and/or reorient) the structural members 3321a, 3321b about or at a corresponding joint 3320a, 3320b. For example, the robotic arm 3300 may be able to rotate a full 360° about the joint 3320a with respect to the robot base 3310, or the structural members 3321a, 3321b may rotate a full 360° at any point where they connect to joints 3320a, 3320b connect. The robotic arm 3300 may further translate anywhere within a half-spherical, three-dimensional space, where the fully extended length of the robot arm 3300 (i.e. straightened, or 180°), acts as the radius of the half-spherical, three-dimensional space, measured from the central axis of the robot base 3310 (i.e. where the robot arm 3320 connects to the robot base 3310) to the tip or end of the end effector apparatus 3330.

The connected structural members 3321a, 3321b and joints 3320a, 3320b may form a kinetic chain configured to manipulate the end effector apparatus 3330 configured to execute one or more tasks (e.g., gripping, spinning, welding, etc.) depending on the desired use of the robot 3300. The robot 3300 may include actuation devices such as motors, actuators, wires, artificial muscles, electroactive polymers, etc. (not shown) configured to drive or manipulate (e.g., displace and/or reorient) the end effector apparatus 3330. In general, the end effector apparatus 3330 can provide capabilities to grasp objects 3410A/3410B/3410C/3410D/3401 of various sizes and shapes. The objects 3410A/3410B/3410C/3410D/3401 may be any object, including, for example, a rod, bar, gear, bolt, nut, screw, nail, rivet, spring, linkage, cog, disc, washer, or any other type of physical object, as well as assemblies of multiple objects. The end effector apparatus 3330 may include at least one gripper 3332 having gripping fingers 3332a, 3332b, as exemplified in FIG. 3C. The gripping fingers 3332a, 3332b can translate with respect to each other to pinch, grasp, or otherwise secure the objects 3410A/3410B/3410C/3410D/3401. In embodiments, the end effector apparatus 3330 includes at least two grippers 3332, 3334 having gripping fingers 3332a, 3332b, 3334a, 3334b, respectively, as exemplified in FIG. 3D. Gripping fingers 3332a, 3332b may translate with respect to each other, and gripping fingers 3334a, 3334b may translate with respect to each other, to pinch, grasp, or otherwise secure the objects 3410A/3410B/3410C/3410D/3401. In embodiments, the end effector apparatus 3330 may include three or more grippers (not shown), and/or grippers with more than two gripping fingers (not shown), each with translational capabilities designed for pinching, grasping, or otherwise securing objects.

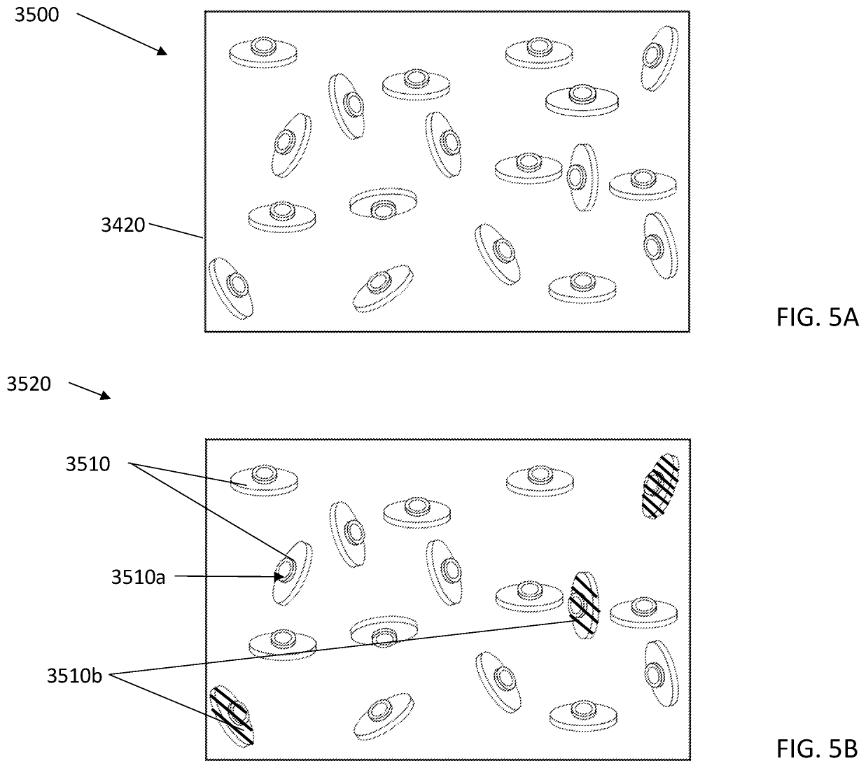

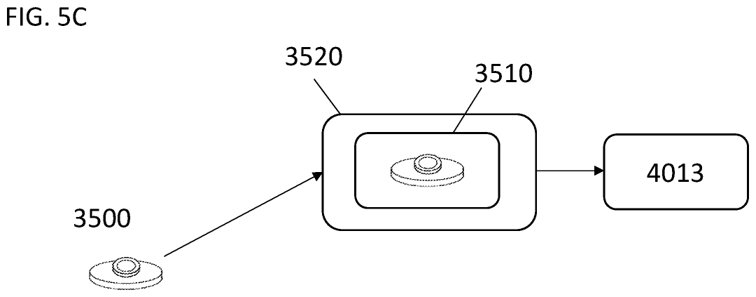

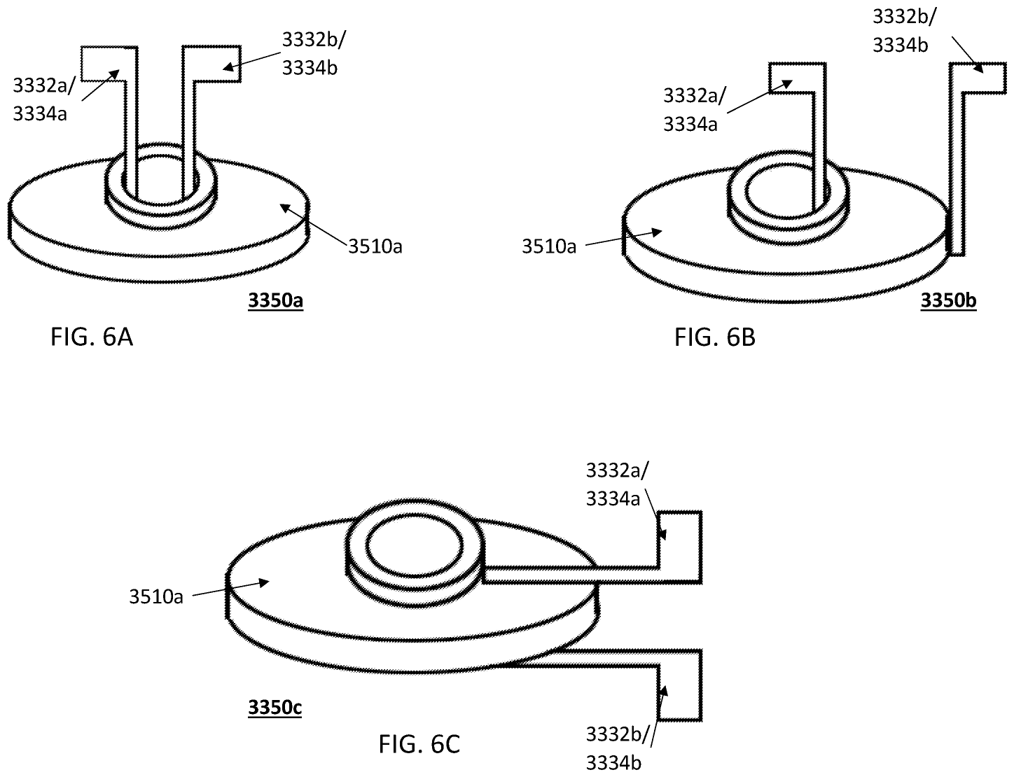

The robot 3300 may be configured for location in an object handling environment 3400 including a container 3420 having objects 3410A/3410B/3410C/3410D/3401 disposed on or therein, for delivery or transfer to a destination 3440 within the object handling environment 3400. The container 3420 may be any container suitable for holding the objects 3410A/3410B/3410C/3410D/3401, such as a bin, box, bucket, or pallet, for example. The objects 3410A/3410B/3410C/3410D/3401 may be any object, including, for example, a rod, bar, gear, bolt, nut, screw, nail, rivet, spring, linkage, cog, disc, washer, or any other type of physical object, as well as assemblies of multiple objects. For example, the objects 3410A/3410B/3410C/3410D/3401 may refer to objects accessible from the container 3420 having a mass in the range of, e.g., several grams to several kilograms, and a size in the range of, e.g., 5 mm to 500 mm. For example and illustrative purposes, the description of the method 4000 herein will refer to a ring-shaped object as a target object 3510a (FIGS. 5B and 6A-6C) within a plurality of objects 3500 (as shown in FIG. 5B) with which the computer system 1100 and robot 3300 may interact with using the methods described herein. The plurality of objects 3500 may be substantially the same in terms of size, shape, weight, and material composition. In embodiments, the plurality of objects 3500 may vary from each other in size, shape, weight, and material composition, as previously described. The specific shapes of objects discussed herein are used for example purposes only, and the methods and processes described herein may be used or employed with objects of different shapes as necessary.

Thus, with regards to the above, the computing system 1100 may be configured to operate as follows for transferring a target object from the source or container 3420 to the destination 3440:

FIG. 4 provides a flow diagram illustrating an overall flow of methods and operations for the detection, planning, picking, transferring, and placing of target objects, according to embodiments hereof. The detection, planning, picking, transferring, and placing method 4000 may include any combination of features of the sub-methods and operations described herein. The method 4000 may include any or all of an object detection operation 4002, an object graspability determination operation 4003, a target selection operation 4004, a trajectory determination operation 4005, a picking/gripping procedure determination operation 4006, a robot arm/end effector apparatus trajectory execution operation 4008, an end effector interaction operation 4010, and a destination trajectory execution operation 4012 to control the robot arm 3320. The object detection operation 4002 may be performed in real time or in a pre-processing or offline environment outside the context of robotic operation. Thus, in some embodiments, these operations and methods may be performed in advance to facilitate later action by a robot. The object detection operation 4002 and an object graspability determination operation 4003 may be the first steps in a planning portion of the method 4000. The target selection operation 4004, the trajectory determination operation 4005, and the picking/gripping procedure determination operation 4006 may provide the remaining steps of the planning portion and may be performed multiple times during the method 4000. The robot arm/end effector apparatus trajectory execution operation 4008, end effector interaction operation 4010, and destination trajectory execution operation 4012 for controlling the robot arm 3320 may each be performed in the context of robotic operation for detecting, identifying, and retrieving the target objects from a container.

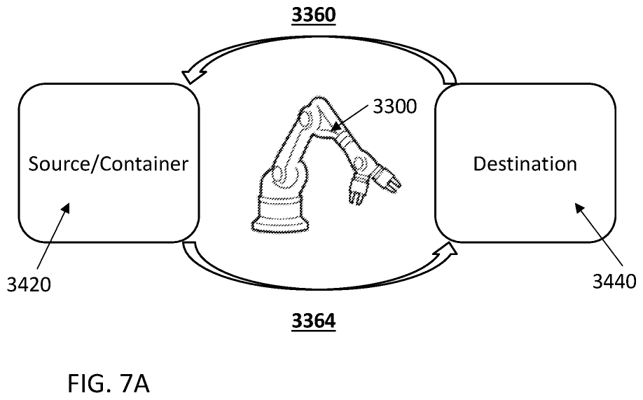

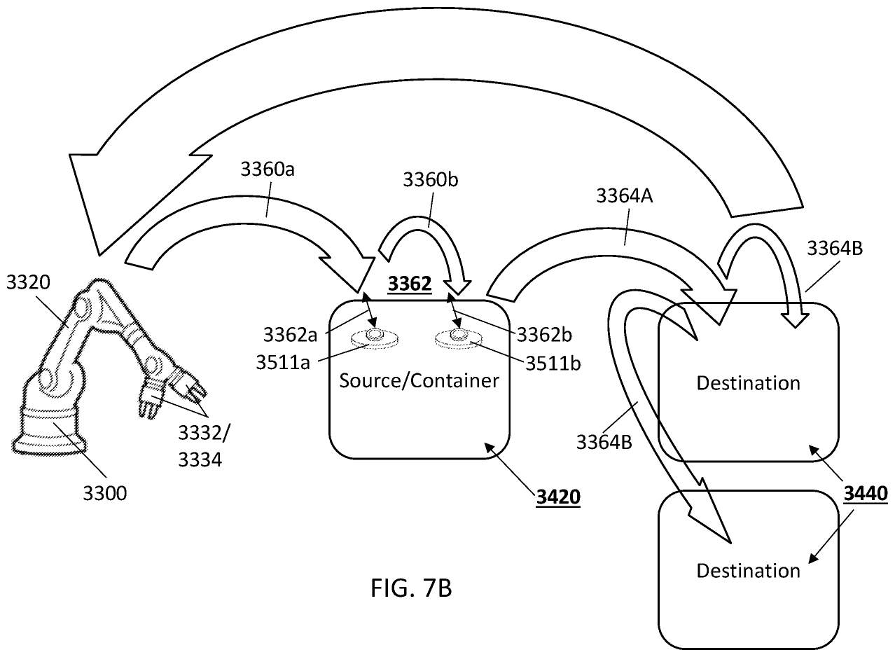

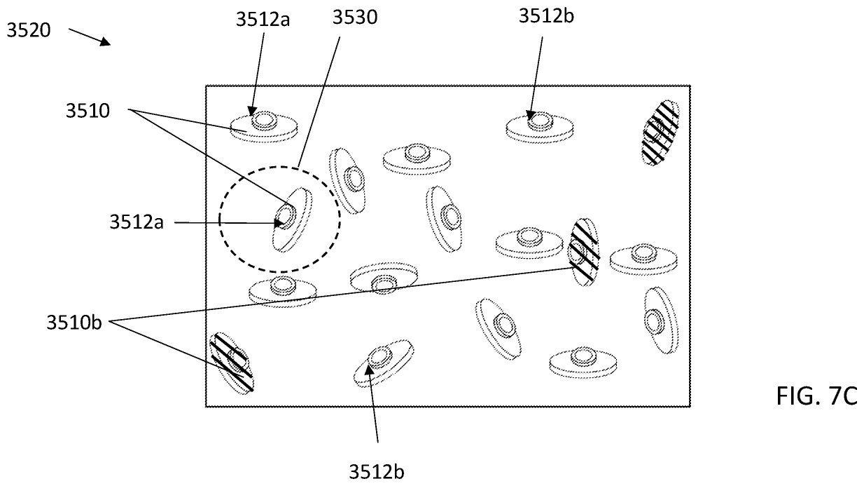

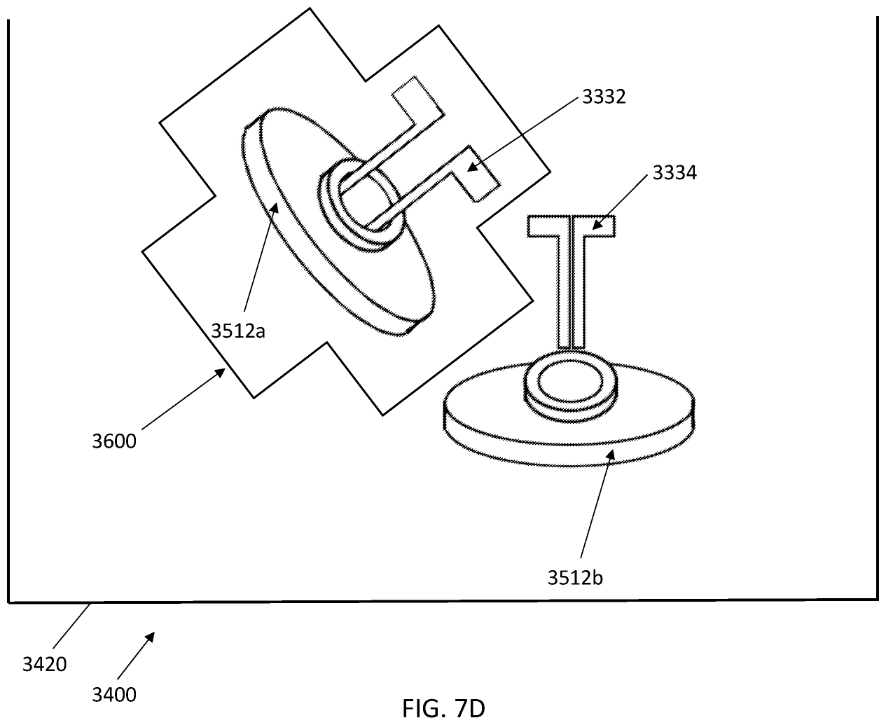

In an operation 4002, the method 4000 includes detecting the plurality of objects 3500 in the container or source of objects 3420 via the camera 1200. The objects 3500 may represent a plurality of physical, real-world objects (FIG. 5A). The operation 4002 may generate a detection result 3520 for one or more of the objects 3500 in the container 3420. The detection result 3520 may include a digital representation of the plurality of objects 3500 in the container 3420 (FIG. 5B) which may individually be referred to as detected objects 3510. Further operations of the method 4000 may determine from the detected objects 3510 which are target object 3510a or target objects 3511a/3511b (e.g., as discussed with respect to FIG. 7B, and/or ungraspable objects 3510b.

The operation 4002 may include analyzing information received from the camera 1200 (e.g., image information) to generate the detection result 3520 (FIG. 5C), according to methods described herein. The information received from the camera 1200 may include images of the environment 3400, of the object container 3420, of the plurality of objects 3500. As discussed above, the plurality of objects 3500 may include detected objects 3510.

Generating the detection result 3520 may include identifying the plurality of objects 3500 in the object container 3420 to subsequently identify detected objects 3510, from which the target object 3510a or target objects 3511a/3511b to be picked and transferred via the robot 3300 to the destination 3440 will later be determined. FIG. 5B provides a visual depiction of the detection result 3520 for multiple detected objects 3510 amongst the plurality of objects 3500 in the container 3420 (their physical representation provided as FIG. 5A). FIG. 5C illustrates the physical object 3500 existing in the physical world, while the detected object 3510 refers to a representation of the physical object 3500 that is described by the detection result 3520. The detection result 3520 may include information about each of the detected objects 3510, for example, a plurality of object representations 4013, about each of the detected objects 3510, including the detected objects' 3510 location within the container 3420, the detected objects' 3510 location relative to other detected objects 3510 (e.g. whether the detected object 3510 is on the top of the pile of the plurality of objects 3500 or below other adjacent detected objects 3510), orientation and pose of the detected objects 3510, degree of confidence of the object detection, available grasping models 3350a/3350b/3350c (as described in greater detail below), or a combination thereof.

Operation 4002 of the method 4000 may therefore include obtaining, based on the object detection, a detection result 3520 including a plurality of object representations 4013. The computer system 1100 may use the plurality of object representations 4013 of all detected objects 3510 from the detection result 3520 in determining effective grasping models 3350a/3350b/3350c. Each of the detected objects 3510 may have a corresponding detection result 3520, which represents digital information (i.e. the object representations 4013) about each of the detected objects 3510. In embodiments, the corresponding detection result 3520 may incorporate a plurality of detected objects 3510 amongst the plurality of objects 3500 physically present in the real-world. The detected objects 3510 may represent digital information (i.e. the object representations 4013) about each of the objects 3500 that are detected.

In an embodiment, identifying the plurality of objects 3500 to obtain the detection result 3520 may be carried out by any suitable means. In embodiments, identifying the plurality of objects 3500 may include a process including object registration, template generation, feature extraction, hypothesis generation, hypothesis refinement, and hypothesis validation, as performed, for example, by the hypothesis generation module 1128, the object registration module 1130, the template generation module 1132, the feature extraction module 1134, the hypothesis refinement module 1136, and the hypothesis validation module 1138. These processes are described in detail in U.S. patent application Ser. No. 17/884,081, filed Aug. 9, 2022, the entire contents of which are incorporated herein in their entirety.

Object registration is a process that includes obtaining and using object registration data, e.g., known, previously stored information related to an object 3500, to generate object recognition templates for use in identifying and recognizing similar objects in a physical scene. Template generation is a process that includes generating sets of object recognition templates for the computing system to use in identifying the objects 3500 for further operations related to object picking. Feature extraction (also referred to as feature generation) is a process that includes extraction or generation of features from object image information for use in object recognition template generation. Hypothesis generation is a process that includes generating one or more object detection hypotheses, for example based on a comparison between object image information and one or more object recognition templates. Hypothesis refinement is a process to refine matching of the object recognition template with the object image information, even in scenarios where the object recognition template does not match exactly to the object image information. Hypothesis validation is a process by which a single hypothesis from multiple hypotheses is selected as a best fit or best choice for an object 3500.

In an operation 4003, the method 4000 includes identifying graspable objects from among the plurality of objects 3500. As a step in a planning portion of the method 4000, the operation 4003 includes determining the graspable and ungraspable objects from the detected objects 3510. The operation 4003 may be performed based on the detected objects 3510 to assign a grasping model to each detected object 3510 or determine that a detected object 3510 is an ungraspable object 3510b.

The grasping models 3350a/3350b/3350c describe how the detected objects 3510 can be grasped by the end effector apparatus 3330. For illustrative purposes, FIGS. 6A-6C exemplify three different grasping models 3350a/3350b/3350c for gripping the target object 3510a, although it should be understood that other grasping models are possible.

FIG. 6A illustrated as grasping model 3350a demonstrates an inner chuck such that the gripper fingers 3332a/3332b/3334a/3334b perform a reverse pinching motion against the inner walls of the ring of the target object 3510a (i.e. the gripper fingers 3332a/3332b/3334a/3334b translate outward, or away from each other, once both are within the ring of the target object 3510a).

FIG. 6B illustrates a grasping model 3350b that demonstrates an in-out chuck such that the gripper fingers 3332a/3332b/3334a/3334b pinch the inner walls of, and the outer side of, the ring of the target object 3510a.

FIG. 6C illustrated as grasping model 3350c demonstrates a side chuck where the gripper fingers 3332a/3332b/3334a/3334b pinch the outer disk portion of the ring of the target object 3510a.

Each of the grasping models 3350a/3350b/3350c may be ranked according to factors such as projected grip stability 4016 which may have an associated transfer speed modifier which may determine the velocity, acceleration, and/or deceleration at which an object can be moved by the robot arm 3320. For example, the associated transfer speed modifier is a value that determines the movement speed of the robot arm 3320 and/or end effector apparatus 3330. The value may be set between zero and one, where zero represents a full stop (e.g. no movement; completely stationary) and one represents a maximum operating speed of the robot arm 3320 and/or end effector apparatus 3330. The transfer speed modifier may be determined offline (e.g. through real-world testing) or in real time (e.g. via computer modeling simulations to account for friction, gravity, and momentum).

Projected grip stability 4016 may further be an indicator of how secure the target object 3510a is once grasped by the end effector apparatus 3330. For example, grasping model 3350a may have a higher projected grip stability 4016 than grasping model 3350b, and grasping model 3350b may have a higher projected grip stability 4016 than grasping model 3350c. In other examples, different grasping models 3350 may be ranked differently according to projected grip stability 4016.

Processing of the detection result 3520 may provide data indicative of whether each of the detected objects 3510 may be grasped by one or more of the grasping models, based on the plurality of object representations 4013 about each of the detected objects 3510, including the detected objects' 3510 location within the container 3420, the detected objects' 3510 location relative to other detected objects 3510 (e.g. whether the detected object 3510 is on the top of the pile of the plurality of objects 3500 or below other adjacent detected objects 3510), orientation and pose of the detected objects 3510, degree of confidence of the object detection, available grasping models 3350a/3350b/3350c (as described in greater detail below), or a combination thereof. For example, one of the detected objects 3510 may be grasped according to grasping model 3350a and 3350b, but not grasping model 3350c.

Detected objects 3510 may be determined as ungraspable objects 3510b when no grasping model can be found for the object. For example, the detected objects 3510 may not be accessible for grasp (because they are covered, at an odd angle, partially buried, partially obscured, etc.) by any of the grasping models 3350a/3350b/3350c, and thus may not be graspable by the end effector apparatus 3330. The ungraspable objects 3510b may be pruned from the detection result 3520, e.g., by removing them from the detection result 3520 or by flagging them as ungraspable so that no further processing is performed on them.

Pruning ungraspable objects 3510b from the plurality of objects 3500 and/or the detected objects 3510 may further be performed according to the following. In embodiments, the ungraspable objects 3510b are further determined and pruned from the remaining detected objects 3510 to be evaluated for the target object 3510a based on at least one of the plurality of object representations 4013 of the detection result 3520. As previously mentioned above, the object representations 4013 of each of the detected objects 3510 includes, inter alia, the detected objects' 3510 location within the container 3420, the detected objects' 3510 location relative to other detected objects 3510, the orientation and pose of the detected objects 3510, the degree of confidence of the object detection, available grasping models 3350a/3350b/3350c, or a combination thereof. For example, the ungraspable objects 3510b may be located in the container 3420 in a manner that does not allow for practical access by the end effector apparatus 3330 (e.g. the ungraspable object 3510b is propped up against a wall or corner of the container). The ungraspable object 3510b may be determined to be unavailable for picking/grasping by the end effector apparatus 3330 due to the ungraspable object's 3510b orientation (e.g. the orientation/pose of the ungraspable object 3510b is such that the end effector apparatus 3330 cannot practically grasp or pick up the ungraspable object 3510b using any of the available grasping models 3350a/3350b/3350c). The ungraspable objects 3510b may be surrounded by or covered by other detected objects 3510 in a manner that does not allow for practical access by the end effector apparatus 3330 (e.g. the ungraspable object 3510b is located in the bottom of the container covered by other detected objects 3510, the ungraspable object 3510b is wedged between multiple other detected objects 3510, etc.). The computer system 1100, in detecting the plurality of objects as previously described in operation 4002, may output a low degree of confidence in detecting the ungraspable object 3510b (e.g. the computer system 1100 is not completely certain/confident that the ungraspable object 3510b is properly identified, in comparison to the other detected objects 3510).

As a further example, the ungraspable objects 3510b may be detected objects 3510 having no available grasping models 3350a/3350b/3350c based on the detection result 3520. For example, an ungraspable object 3510b may be determined by the computer system 1100 to be unavailable for picking/grasping by the end effector apparatus 3330 by any of the grasping models 3350a/3350b/3350c due to any combination of the aforementioned object representations 4013, including, inter alia, the ungraspable object's 3510b location in the container, location with respect to other detected objects 3510, orientation, degree of confidence, or type of object, as further described herein. An ungraspable object 3510b may be determined by the computer system 1100 due to the ungraspable object 3510b having no available grasping models 3350a/3350b/3350c unavailable. For example, an ungraspable object 3510b may be determined by the computer system 1100 due to the ungraspable object 3510b having a lower projected grip stability 4016 or other measured variable than the other detected objects 3510, as further described herein with respect to the picking/gripping procedure operation 4006.

The remaining graspable objects may be ranked or ordered according to one or more criteria. The graspable objects may be ranked according to any combination of detection confidence (e.g., confidence in the detection result associated with the object), object position (e.g., ease of access, objects that are not obscured, obstructed, or buried may have a higher rank) and a ranking of a grasp model identified for the graspable object.

In an operation 4004, the method 4000 includes target selection. In the operation 4004, a target object 3510a or target objects 3511a/3511b may be selected from the graspable objects.

Referring now to FIGS. 7C and 7D, the graspable objects identified by the operation 4003 may be candidate objects 3512a/3512b. The candidate objects 3512a/3512b may be further pruned by eliminating or removing any objects that do not have an inverse kinematic solution. The candidate objects 3512a/3512b lacking an inverse kinematic solution (e.g. a solution for the robot arm 3320 to move itself into a position to allow for grasping of the candidate object 3512a/3512b and then depart from a grasping operation). For example, if the calculated configuration of the robot 3300 to reach the candidate object 3512a/3512b violates constraints of the robot 3300, robot arm 3320, and/or end effector apparatus 3330, no inverse kinematic solution may be found. In determining whether inverse kinematic solutions exist for candidate objects 3512a/3512b, the computing system 1100 may determine trajectories for the candidate objects 3512a/3512b, for example according to the methods discussed below with respect to operation 4005. In an example, a graspable detected object 3510 may be located in an area of the object source 3420 that disallows the robot arm 3320 the correct positioning or configuration to properly grasp that particular candidate object 3512a/3512b or to depart after grasping the candidate object 3512a/3512b.

For each candidate object candidate object 3512a/3512b from among the graspable objects the following may be performed. The candidate objects may be selected for processing, for example, in an order according to the ranking of graspable objects described above.

As shown in FIG. 7C, candidate objects 3512a will be referred to as primary candidate objects 3512a, e.g., objects which may be first objects in a dual picking operation. Candidate objects 3512b may be secondary candidate objects 3512b, e.g., objects which may be second objects in a dual picking operation.

For each primary candidate object 3512a, the remaining secondary candidate objects 3512b may be filtered or pruned according to the following. First, secondary objects 3512b within a disturbance range 3530 of the primary candidate object 3512a may be pruned. The disturbance range 3530 represents a minimum distance from a first object at which other nearby objects are unlikely to shift in position or pose when the first object is removed from pile of objects. The disturbance range 3530 may depend on the size of the objects and/or on their shape (larger objects may require a greater range and some object shapes may cause greater disturbances when moved). Accordingly, secondary candidate objects 3512b that are likely to be disturbed or moved during grasping of the primary candidate object 3512a may be pruned.

The remaining secondary candidate objects 3512b may further be filtered or pruned according to a similarity of grasping models 3350a/3350b/3350c identified for the primary candidate object 3512a and the secondary candidate object 3512b. In embodiments, secondary candidate objects 3512b may be pruned if they have an assigned grasping model that differs from that of the primary candidate object 3512a. In embodiments, secondary candidate objects 3512b may be pruned if a grip stability of a grasping model 3350a/3350b/3350c assigned to the secondary candidate object 3512b differs by more than a threshold value from the grip stability of the grasping model 3350a/3350b/3350c assigned to the primary candidate object 3512a. Object transfer may be optimized by providing robotic motion at a maximum speed. As discussed above with respect to the different grasping models 3350a/3350b/3350c, some grasping models 3350a/3350b/3350c have greater grip stability and thereby permit greater speed of robotic motion. Selecting a primary candidate object 3512a and a secondary candidate object 3512b having grasping models 3350a/3350b/3350c that are the same or have similar grip stability allows for increased speed of robotic motion. In the case where the grip stabilities are different, speed of robotic motion is limited to the speed allowed by the lower grip stability. Thus, in scenarios where multiple objects with high grip stability are available and multiple object with low grip stability are available, it is advantageous to pair the objects with high grip stability and the objects with low grip stability.

The remaining secondary candidate objects 3512b may further be filtered or pruned according to an analysis of potential trajectories between the primary candidate object 3512a and the secondary candidate objects 3512b. If an inverse kinematic solution cannot be generated between the primary candidate object 3512a and a secondary candidate objects 3512b, the secondary candidate object 3512b may be pruned. As discussed above, inverse kinematic solutions may be identified through trajectory determinations similar to those described with respect to operation 4005.

Next, it may be determined grasping the primary candidate object 3512a may interfere with grasping the secondary candidate object 3512b. Referring now to FIG. 7D, a bounding box 3600 may be generated by the computer system 1100 around at least one of the grippers 3332/3334 designated for interaction with each of the primary objects 3512a and secondary objects 3512b as exemplified in FIG. 7D. The bounding box 3600 may be used by the computer system 1100 to determine if the pose of the gripper 3332/3334 while gripping the primary candidate object 3512a (having the bounding box 3600 generated around it) will result in a collision between the bounding box 3600 and the object handling environment 3400/object source or container 3420 and/or other objects of the plurality of objects 3500, when the second of the grippers 3332/3334 attempts to approach, move, interact with, grasp, or depart from the secondary candidate object 3512b. In doing so, the computer system 1100 can determine whether the primary objects 3512a and secondary objects 3512b grasped by the gripper 3332/3334 subjected to the bounding box 3600 will collide with other objects 3500 and/or the object handling environment 3400 in a manner that may result in the primary candidate object 3512a being knocked from the grasp of the gripper 3332/3334 during grasping of the secondary candidate object 3512b.

Other means of filtering or pruning the secondary candidate objects 3512b may further be employed. For example, in embodiments, secondary objects 3512b having differing orientations than the primary object 3512a may be pruned. In embodiments, secondary objects 3512b having differing object types or models than the primary object 3512a may be pruned.

After pruning the secondary candidate objects 3512b, object pairs may be generated between primary candidate objects 3512a and unpruned secondary candidate objects 3512b for trajectory determination. In embodiments, each primary candidate object 3512a may be assigned a single secondary candidate object 3512b to form an object pair. In the case of multiple unpruned secondary candidate objects 3512b, a single secondary candidate object 3512b may be selected according to, for example, an easiest or fastest trajectory between the primary candidate object 3512a and the secondary candidate object 3512b and/or based on the ranking of graspable objects, as discussed above with respect to operation 4003. In further embodiments, each primary candidate object 3512a may be assigned multiple secondary candidate objects 3512b to form multiple object pairs and a trajectory may be computer for each. In such an embodiment, a fastest or easiest trajectory may be selected to finalize the pairing between a primary candidate object 3512a and a secondary candidate object 3512b.

Once the primary objects 3512a are paired with respective secondary objects 3512b from the graspable objects, the computer system 1100 may designate each primary object 3512a paired with a respective secondary object 3512b as a target object 3511a/3511b for grasping determination, robot arm trajectory execution, end effector interaction, and destination trajectory execution, as detailed in operations 4006/4008/4010/4012 respectively herein.

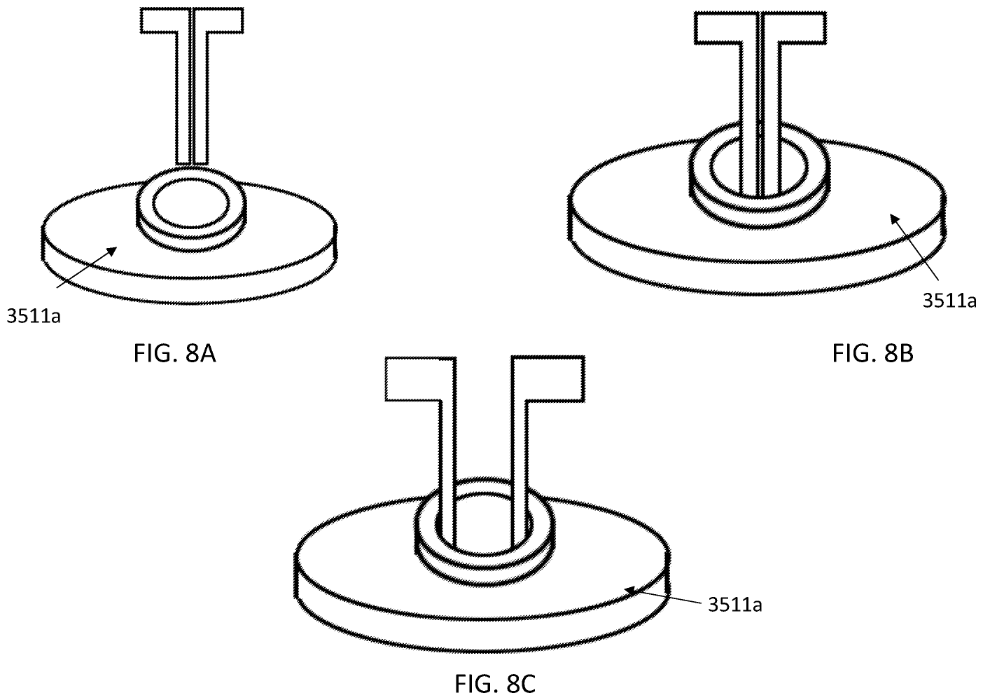

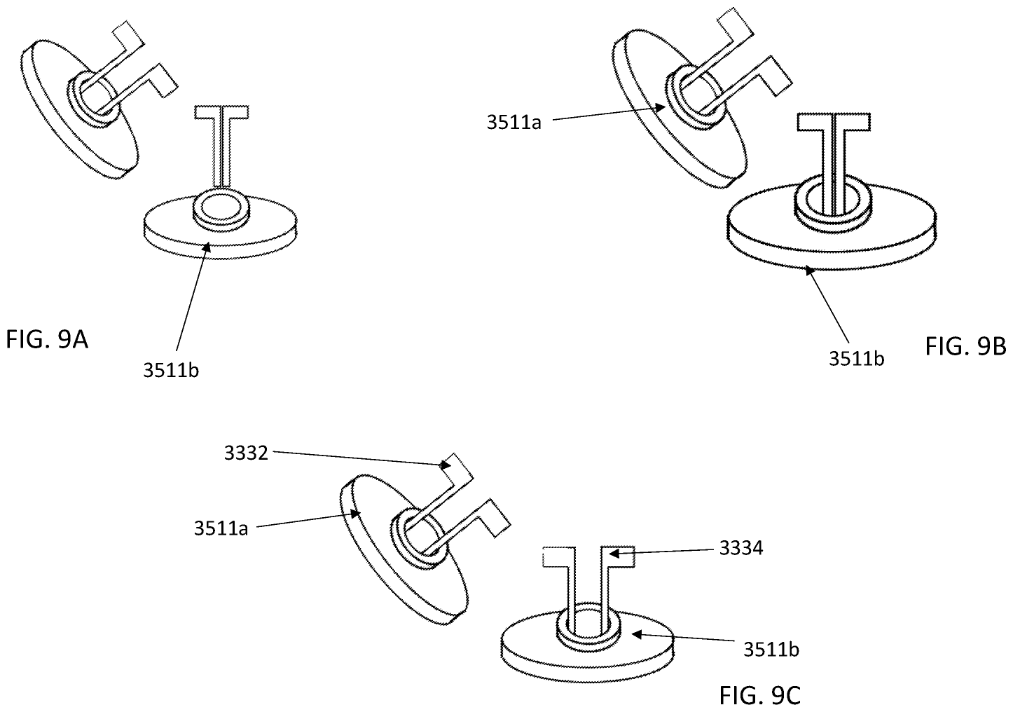

In embodiments, a first target object 3511a of the plurality of target objects 3511a/3511b is associated with a first grasping model 3350a/3350b/3350c, and a second target object 3511b of the plurality of target objects 3511a/3511b is associated with a second grasping model 3350a/3350b/3350c. The grasping model 3350a/3350b/3350c selected for the first target object 3511a may be similar to or the same as the grasping model 3350a/3350b/3350c selected for the second target object 3511b, as discussed above, based on at least one of the plurality of object representations 4013 of the detection result 3520. For example, the first target object 3511a may be grasped by the gripper 3332 using the grasping model 3350a, where the gripper fingers 3332a, 3332b perform an inner chuck, or a reverse pinching motion against the inner walls of the ring of the first target object 3511a, as illustrated in FIGS. 8A-8C. The second target object 3511b may also be grasped by the gripper 3334 using the grasping model 3350a, where the gripper fingers 3334a, 3334b perform an inner chuck, or a reverse pinching motion against the inner walls of the ring of the target object 3511b, as illustrated in FIGS. 9A-9C.

In an operation 4005, the method 4000 may include determining robot trajectories. The operation 4005 may include at least determining an arm approach trajectory 3360, determining an end effector apparatus approach trajectory 3362, and determining a destination approach trajectory 3364.

The operation 4005 may include determining an arm approach trajectory 3360, an end effector apparatus approach trajectory 3362, and a destination approach trajectory 3364 for the robot arm 3320 to approach the plurality of objects 3500. FIG. 7A illustrates a motion plan for a transfer cycle of a target object 3510a by a robotic arm 3320 and end effector apparatus 3330 from a source (i.e. the container 3420) to a destination 3440. A transfer cycle refers to the full cycle of movement by the robotic arm 3320 to effect transfer of an object from an object source or container to a destination 3440. In embodiments, the operation 4005 includes determining multiple arm approach trajectories 3360a/3360b for the robot arm 3320 to approach the plurality of objects 3500. FIG. 7B illustrates a motion plan for a transfer cycle of a plurality of target objects 3511a/3511b by a robotic arm 3320 and end effector apparatus 3330 from a source (i.e. the container 3420) to a destination 3440.

In the operation 4005, the computer system 1100 determines the arm approach trajectory 3360, wherein the arm approach trajectory includes the path over which the robot arm 3320 is controlled to move or translate in a direction towards the vicinity of the source or container 3420. In determining such an arm approach trajectory 3360, the quickest path is desired (e.g., the path that allows for the least amount of time taken for the robot arm 3320 to translate from its current position to the vicinity of the source or container 3420), based on factors such as shortest travel distance from the robot arm's 3320 current location to the container 3420 and/or the maximum available speed of travel of the robot arm 3320. In determining the maximum available speed of travel, the status of the end effector apparatus 3330 is further determined, i.e. whether the end effector apparatus 3330 currently has a target object 3510a or target objects 3511a/3511b in its grip. In embodiments, the end effector apparatus 3330 is not gripping any target object 3510a or target objects 3511a/3511b, and thus the maximum speed available to the robot arm 3320 can be used for the arm approach trajectory 3360 as the instance of a target object 3510a or target objects 3511a/3511b slipping/falling off the end effector apparatus 3330 is nullified. In embodiments, the end effector apparatus 3330 may have at least one target object 3510a or target objects 3511a/3511b grasped by its grippers 3332/3334, and thus the speed of travel of the robot arm 3320 is calculated by considering the grip stability of the gripper 3332/3334 on the grasped target object 3510a or target objects 3511a/3511b, as will be described in greater detail below.

In operation 4005, the method 4000 may include determining an end effector apparatus approach trajectory 3362 for the end effector apparatus 3330 to approach the target object 3510a or target objects 3511a/3511b. The end effector apparatus approach trajectory 3362 may represent an anticipated travel path for the end effector apparatus 3330 attached to the robot arm 3320. The computer system 1100 may determine the end effector apparatus approach trajectory 3362, where the robot arm 3320, the end effector apparatus 3330, or a combination of the robot arm 3320 and end effector apparatus 3330 are controlled to move or translate in a direction towards the target object 3510a or target objects 3511a/3511b in the container 3420. In embodiments, the end effector apparatus approach trajectory 3362 is determined once the robot arm trajectory 3362 is determined such that the robot arm 3320 will end its trajectory at or within the vicinity of the source or container 3420. The end effector apparatus approach trajectory 3362 may be determined in a manner where the gripper fingers 3332a/3332b/3334a/3334b of the gripper 3332/3334 will be placed adjacent to the target object 3510a or target objects 3511a/3511b so the gripper fingers 3332a/3332b/3334a/3334b of the gripper 3332/3334 may properly grasp the target object 3510a or target objects 3511a/3511b in a manner consistent with the determined grasping model 3350a/3350b/3350c, as previously described above.

FIG. 7B illustrates another embodiment of a motion plan for a transfer cycle of a plurality of target objects 3511a/3511b by a robotic arm 3320 and end effector apparatus 3330 from a source or container 3420 to a destination 3440. In embodiments, the computer system 1100 determines an arm approach trajectory 3360, where the robot arm 3320 is controlled to move or translate in a direction towards the vicinity of the source or container 3420. In determining such an arm approach trajectory 3360, the shortest/quickest path is desired, based on factors such as shortest travel distance from the robot arm's 3320 current location to the container 3420, and/or the maximum available speed of travel of the robot arm 3320. In determining the maximum available speed of travel, the status of the end effector apparatus 3330 is further determined, i.e. whether the end effector apparatus 3330 currently has a target object 3510a or target objects 3511a/3511b in its grip. In examples of trajectories, the end effector apparatus 3330 is not gripping any target object 3510a or target objects 3511a/3511b, and thus the maximum speed available to the robot arm 3320 can be utilized for the arm approach trajectory 3360 as the instance of a target object 3510a or target objects 3511a/3511b slipping/falling off the end effector apparatus 3330 is nullified. In other examples, the end effector apparatus 3330 may have at least one target object 3510a or target objects 3511a/3511b grasped by its grippers 3332/3334, and thus the speed of travel of the robot arm 3320 is calculated by considering the grip stability of the gripper 3332/3334 on the grasped target object 3510a or target objects 3511a/3511b, as will be described in greater detail below.

FIG. 7B further illustrates a plurality of end effector apparatus approach trajectories 3362a/3362b used to pick or grasp target objects 3511a/3511b. In embodiments, the computer system 1100 may determine the end effector apparatus approach trajectory 3362/3362a/3362b, where the robot arm 3320, the end effector apparatus 3330, or a combination of the robot arm 3320 and end effector apparatus 3330 are controlled to move or translate in a direction towards the target object 3510a or target objects 3511a/3511b in the source or container 3420. In embodiments, the end effector apparatus approach trajectory 3362/3362a/3362b is determined once the robot arm trajectory 3362 is determined such that the robot arm 3320 will end its trajectory at or within the vicinity of the source or container 3420. The end effector apparatus approach trajectory 3362/3362a/3362b may be determined in a manner where the gripper fingers 3332a/3332b/3334a/3334b of the gripper 3332/3334 will be placed adjacent to the target object 3510a or target objects 3511a/3511b so the gripper fingers 3332a/3332b/3334a/3334b of the gripper 3332/3334 may properly grasp the target object 3510a or target objects 3511a/3511b in a manner consistent with the determined grasping model 3350a/3350b/3350c, as previously described above. The end effector approach trajectory 3362/3362a/3362b may further be determined by the status of the gripper 3332/3334, i.e., whether a target object 3510a or target objects 3511a/3511b is currently gripped by at least one gripper 3332/3334. In such a scenario, determining the end effector apparatus approach trajectory 3362/3362a/3362b is based on an optimized end effector apparatus approach time for the end effector apparatus 3330 in the grasp operation to grasp the target object 3510a or target objects 3511a/3511b, wherein the optimized end effector apparatus approach time is a determined most efficient end effector apparatus approach time based on the calculations described below. The optimized end effector apparatus approach time is calculated based on the grip stability of the gripper 3332/3334 on the grasped target object 3510a or target objects 3511a/3511b.

In embodiments, the optimized end effector apparatus approach time is determined according to an available grasping model 3350a/3350b/3350c for the target object 3510a or target objects 3511a/3511b. For example, the amount of time needed for the end effector apparatus 3330 to properly place the gripper 3332/3334 adjacent to the target object 3510a or target objects 3511a/3511b in a manner that would allow the gripper fingers 3332a/3332b/3334a/3334b to properly grasp the target object 3510a or target objects 3511a/3511b in accordance with the chosen grasping model 3350a/3350b/3350c is factored into the optimized end effector apparatus approach time. The amount of time needed to properly execute grasping model 3350a, may be shorter or longer than the amount of time needed to properly execute grasping model 3350b or grasping model 3350c. The grasping model 3350a/3350b/3350c with the determined least amount of time needed to properly execute the grip may thus be chosen for the target object 3510a or target objects 3511a/3511b to be picked or grasped by the gripper 3332/3334 of the end effector apparatus 3330. The chosen grasping model may be selected based on a balancing of factors, for example, by balancing the determined least amount of time needed to properly execute the grip 3350a/3350b/3350c with the projected grip stability 4016, such that the faster grasping model 3350a/3350b/3350c may be passed over for the second fastest grasping model 3350a/3350b/3350c in the interest of sacrificing speed over poorer projected grip stability 4016, and lowering the likelihood of grip failure (i.e. dropping, displacing, throwing, or otherwise mishandling the target object 3510a or target objects 3511a/3511b after being picked or grasped by the gripper 3332/3334 of the end effector apparatus 3330).

In the operation 4005, the method 4000 may further include determination of one or more destination approach trajectories 3364 (illustrated in FIG. 7B as destination approach trajectories 3364a and 3364b). In embodiments, determining the destination trajectories 3364a/3364b of the robot arm 3320 may be based on an optimized destination trajectory time for the robot arm 3320 to travel from the container 3420 to one or more destination(s) 3440. The optimized destination trajectory time may be a determined most efficient destination trajectory time for the robot arm 3320 to travel from container 3420 to destination(s) 3440. For example, the optimized trajectory time may be determined by the shortest path between the robot arm's 3320 current location (e.g. at or near the container 3420) and the destination(s) 3364. The optimized trajectory time may be determined by the path which the robot arm 3320 may travel the fastest without impediment towards the destination(s) 3364. In embodiments, determining the destination trajectory 3364 of the robot arm 3320 is based on a projected grip stability 4016 between the end effector apparatus 3330 and the target object 3510a or target objects 3511a/3511b. For example, a projected grip stability 4016 with a higher value may indicate a stronger grip or hold the gripper fingers 3332a/3332b/3334a/3334b of the grippers 3332/3334 may have on the target object 3510a or target objects 3511a/3511b, which may allow for faster movement of the robot arm 3320 and/or end effector apparatus 3330 while traversing the destination trajectory 3364 towards the destination(s) 3440. Conversely, a projected grip stability 4016 with a lower value may indicate a weaker grip or hold the gripper fingers 3332a/3332b/3334a/3334b of the grippers 3332/3334 may have on the target object 3510a or target objects 3511a/3511b, which may thus require slower movement of the robot arm 3320 and/or end effector apparatus 3330 while traversing the destination trajectory 3364 towards the destination(s) 3440 to prevent a failure scenario, i.e. the target object(s) 3510a/3511a/3511b being dropped, thrown, or otherwise displaced.

In embodiments, a single destination approach trajectory 3364a may be provided to place both target objects 3511a/3511b in the same destination 3440. The single destination approach trajectory 3364a may include one or more unchucking or ungrasping operations to release the target objects 3511a/3511b. In embodiments, multiple destination approach trajectories 3364a/3364b may be determined to place the target objects 3511a/3511b either in different places in a same destination 3440 or in two different destinations 3440. The second destination approach trajectory 3364b may be determined to transition the end effector apparatus 3332/3334 between the locations within the destination 3440 or between the two destinations 3440.

In an operation 4006, the method 4000 includes determining a picking or gripping procedure for grasping or gripping the target object 3510a or target objects 3511a/3511b with the end effector apparatus 3330 once the end effector apparatus 3330 reaches the target object 3510a or target objects 3511a/3511b at the end of the end effector apparatus approach trajectory 3362/3362a/3362b. The picking or gripping procedure may represent the manner in which the end effector apparatus 3330 approaches, interacts with, contacts, touches, or otherwise grasps the target object 3510a or target objects 3511a/3511b with the gripper 3332/3334. The grasping models 3350a/3350b/3350c describe how the target object 3510a or target objects 3511a/3511b can be grasped by the end effector apparatus 3330. For illustrative purposes, FIGS. 6A-6C exemplify three different grasping models 3350a/3350b/3350c for gripping the target object 3510a or target objects 3511a/3511b, as previously described in detail above, although it should be understood that other grasping models are possible.

Determining the grasp operation may include selecting at least one grasping model 3350a, 3350b, or 3350c from a plurality of available grasping models 3350a/3350b/3350c for use by the end effector apparatus 3330 in the grasp operation determination of operation 4006. In embodiments, the computer system 1100 determines the grasp operation based on the grasping model 3350a/3350b/3350c having the highest valued rank. The computer system 1100 may be configured to determine a rank to each of the plurality of available grasping models 3350a/3350b/3350c according to a projected grip stability 4016 of each of the plurality of grasping models 3350a/3350b/3350c. Each of the grasping models 3350a/3350b/3350c can be ranked according to factors such as projected grip stability 4016, which may have an associated transfer speed modifier which can determine the velocity, acceleration, and/or deceleration at which the target object 3510a or target objects 3511a/3511b can be moved by the robot arm 3320 during execution of the arm approach trajectory 3360 and/or the end effector apparatus approach trajectory 3362. Projected grip stability 4016 may further be an indicator of how secure the target object 3510a or target objects 3511a/3511b are once picked or grasped by the end effector apparatus 3330. In general, the stronger the projected grip stability 4016, or ability of the end effector apparatus 3330 to hold on to the target object(s) 3510a/3511a/3511b, the more likely the robot 3300 is able to move the robot arm 3320 and/or end effector apparatus 3330 through the determined arm approach trajectory 3360 and/or end effector approach trajectory 3362/3362a/3362b while holding/grasping the target object(s) 3510a/3511a/3511b without resulting in a failure scenario, i.e. the target object(s) 3510a/3511a/3511b is dropped, thrown, or otherwise displaced from the gripper.

In an example of determining ranks of each of the grasping models 3350a/3350b/3350c, the computer system 1100 may determine that grasping model 3350a may have a higher projected grip stability 4016 than that of grasping model 3350b, and grasping model 3350b may have a higher projected grip stability 4016 than that of grasping model 3350c. As another example, the detected objects 3510 may not be accessible for grasping by at least one of the grasping models 3350a/3350b/3350c based on the plurality of object representations 4013 corresponding with the detected objects 3510 (i.e. at least one of the detected objects 3510 is in a location or orientation, or is shaped in such a way that would not allow for a particular grasping model 3350a/3350b/3350c to be effectively used), and thus not pickable by the end effector apparatus 3330 via the grasping model 3350a/3350b/3350c at that time. In such a scenario, the remaining grasping models 3350a/3350b/3350c will be measured for projected grip stability 4016. For example, grasping model 3350a may not be available as a choice to pick or grasp the target object 3510a or target objects 3511a/3511b, e.g., based on the previously determined plurality of object representations 4013. Grasping model 3350a may therefore receive the lowest possible rank value, a rank value of null, or no rank at all (i.e. is completely disregarded). Therefore, in in calculating the rank to apply during the grasp operation determination of operation 4006, the projected grip stability 4016 of grasping model 3350a may be excluded. For example, if the projected grip stability 4016 of grasping model 3350b is determined to have a higher value than the projected grip stability of grasping model 3350c, then the grasping model 3350b will receive a higher valued rank, while the grasping model 3350c will receive a lower valued rank (but still higher valued than that of grasping model 3350a). In other examples, inaccessible ones of the grasping models 3350a/3350b/3350c may be included in the ranking procedure but may be assigned a lowest rank.

In embodiments, determining the at least one grasping model 3350a/3350b/3350c for use by the end effector apparatus 3330 is based on the rank of the grasping model with a highest determined value of the projected grip stability 4016. The rank of grasping model 3350a may have a projected grip stability 4016 with a higher value than that of grasping model 3350b and/or 3350c, and thus grasping model 3350a may be ranked higher than grasping model 3350b and/or 3350c. To maximize or optimize the rate of transfer of target object(s) 3510a/3511a/3511b within each transfer cycle, the computer system 1100 may select target object(s) 3510a/3511a/3511b with similar projected grip stability 4016. In embodiments, the computer system 1100 may select a plurality of target objects 3511a/3511b with the same grasping models 3350a/3350b/3350c. The computer system 1100 may compute a motion plan for a transfer cycle while gripping the target objects 3511a/3511b based on the detection result 3520. The goal is to reduce computation time for picking of multiple target objects 3511a/3511b at the source container 3420, while optimizing the transfer rate between the source container 3420 and the destination 3440. In this way, the robot 3300 can transfer both target objects 3511a/3511b at the maximum rate since both target objects 3511a/3511b have the same projected grip stability 4016. Conversely, if the computer system 1100 selected a target object(s) 3510a/3511a/3511b to be grasped by the gripper 3332/3334 of the end effector apparatus 3330 using a grasping model 3350a/3350b/3350c with a higher rank (i.e. a higher determined value of the projected grip stability 4016) and a second target object(s) 3510a/3511a/3511b to be grasped by the gripper 3332/3334 of the end effector apparatus 3330 using a grasping model 3350a/3350b/3350c with a lower rank (i.e. a lower determined value of the projected grip stability 4016), the rate of transfer would be limited or capped by the lower projected grip stability 4016 of the target object(s) 3510a/3511a/3511b with the grasping model 3350a/3350b/3350c having the lower rank. In other words, for consecutive transfer cycles, picking two target objects 3511a/3511b with grasping models 3350a/3350b/3350c having a higher projected grip stability 4016 and higher transfer speed followed by picking two target objects 3511a/3511b with grasping models 3350a/3350b/3350c having a lower projected grip stability 4016 and lower transfer speed is more optimal than consecutive transfer cycles that both include one target object 3511a with a grasping model 3350a/3350b/3350c having a higher projected grip stability 4016 and one target object 3511b with a grasping model 3350a/3350b/3350c having a lower projected grip stability 4016, as both transfer cycles would be limited to a slower transfer rate in the later scenario.

The various trajectory determinations of operation 4005 and the grasp operation determination 4006 are described sequentially with respect to the operations of the method 4000. It is understood that, where suitable and appropriate, various operations of the method 4000 may occur simultaneously to one another or in a different order then presented. For example, trajectory determinations (such as a destination approach trajectory 3364) may be made during the execution of other trajectories. Thus, a destination approach trajectory 3364 may be determined during execution of an arm approach trajectory 3362.

In an operation 4008, the method 4000 may include outputting a first command (e.g., an arm approach command) to control the robot arm 3300 in the arm approach trajectory 3360 to approach the plurality of objects 3500. As illustrated in FIG. 7B, the computer system 1100 may output the first command to control the robot arm 3320 from an area outside the vicinity of the source or container 3420, to a location at or in the vicinity of the source or container 3420. The first command may control the robot arm 3320 to move from an area at or near the destination 3440 over to a location at or in the vicinity of the source or container 3420. In the operation 4008, the method 4000 may include outputting a second command (e.g., an end effector apparatus approach command) to control the robot arm 3320 in the end effector apparatus approach trajectory 3362 to approach the target object 3510a/3511a/3511b (e.g., to cause the end effector apparatus 3330 to approach the target object 3510a/3511a/3511b). As illustrated in FIG. 7B, multiple end effector apparatus approach trajectories 3362a/3362b may be used to approach a plurality of target objects 3511a/3511b.

In an operation 4010, the method 4000 includes outputting a third command (e.g., an end effector apparatus control command) to control the end effector apparatus 3330 in the grasp operation to grasp the target object 3510a or target objects 3511a/3511b. The end effector apparatus 3330 may use the gripping fingers 3332a/3332b/3334a/3334b of the gripper(s) 3332/3334 to grasp the target object(s) 3510a/3511a/3511b using the grasping model(s) 3350a/3350b/3350c previously determined to have the highest rank and/or projected grip stability 4016. The gripping fingers 3332a/3332b/3334a/3334b may be controlled to move or translate in a manner consistent with the predetermined grasping model(s) 3350a/3350b/3350c, once the end effector apparatus 3330 is in contact with the target object(s) 3510a/3511a/3511b.

In an operation 4012, the method 4000 may further include executing a destination trajectory 3364 to control the robot arm 3320 to approach the destination. The operation 4012 may include outputting a fourth command (e.g., a robot arm control command) to control the robot arm 3320 in the destination trajectory 3364. In embodiments, the destination trajectory 3364 may be determined during the trajectory determination operation 4005 discussed above. In embodiments, the destination trajectory 3364 may be determined after the trajectory execution operation 4008, and the end effector interaction operation 4010. In embodiments, the destination trajectory 3364 may be determined by the computer system 1100 at any time prior to execution of the destination trajectory 3364, including during the performing of other operation. In embodiments, the operation 4012 may further include outputting a fifth command (e.g., an end effector apparatus release command) to control the end effector apparatus 3330 to release, ungrasp, or unchuck, the target object 3510a or target objects 3511a/3511b into or at the destination(s) 3440, upon the robot arm 3320 and end effector apparatus 3330 reaching the destination(s) 3440 at the end of the destination trajectory 3364.

At a high level, a motion plan for a transfer cycle of a target object 3510a or target objects 3511a/3511b by a robotic arm 3320 from a source container 3420 to a destination 3440 involves the following operations as illustrated in FIG. 7A: picking a target object 3510a or target objects 3511a/3511b from a source container 3420 3420 location; transferring the a target object 3510a or target objects 3511a/3511b to the destination 3440 location; placement of the target object 3510a or target objects 3511a/3511b at the destination 3440 location, and returning to the source container 3420 location. The overall transfer cycle time is capped by transfer of the a target object 3510a or target objects 3511a/3511b from the source container 3420 3420 to the destination 3440 due to the projected grasp stability 4016 of the target object 3510a or target objects 3511a/3511b by the end effector apparatus 3330 on the robot arm 3320.

In general, the method 4000 described herein may be used for manipulation (e.g., moving and/or reorienting) of a target object (e.g., one of the packages, boxes, cases, cages, pallets, etc. corresponding to the executing task) from a start/source location to a task/destination location. For example, an unloading unit (e.g., a devanning robot) can be configured to transfer the target object from a location in a carrier (e.g., a truck) to a location on a conveyor. Also, the transfer unit can be configured to transfer the target object from one location (e.g., the conveyor, a pallet, or a bin) to another location (e.g., a pallet, a bin, etc.). For another example, the transfer unit (e.g., a palletizing robot) can be configured to transfer the target object from a source location (e.g., a pallet, a pickup area, and/or a conveyor) to a destination pallet. In completing the operation, the transport unit (e.g., a conveyor, an automated guided vehicle (AGV), a shelf-transport robot, etc.) can transfer the target object from an area associated with the transfer unit to an area associated with the loading unit, and the loading unit can transfer the target object (by, e.g., moving the pallet carrying the target object) from the transfer unit to a storage location (e.g., a location on the shelves). Details regarding the task and the associated actions are described above.

For illustrative purposes, the computer system 1100 system is described in the context of a packaging and/or shipping center; however, it is understood that the computer system 1100 can be configured to execute tasks in other environments/for other purposes, such as for manufacturing, assembly, storage/stocking, healthcare, and/or other types of automation. It is also understood that the computer system 1100 can include other units, such as manipulators, service robots, modular robots, etc. (not shown). For example, in some embodiments, the computer system 1100 can include a depalletizing unit for transferring the objects from cage carts or pallets onto conveyors or other pallets, a container-switching unit for transferring the objects from one container to another, a packaging unit for wrapping/casing the objects, a sorting unit for grouping objects according to one or more characteristics thereof, a piece-picking unit for manipulating (e.g., for sorting, grouping, and/or transferring) the objects differently according to one or more characteristics thereof, or a combination thereof.

It will be apparent to one of ordinary skill in the relevant arts that other suitable modifications and adaptations to the methods and applications described herein can be made without departing from the scope of any of the embodiments. The embodiments described above are illustrative examples and it should not be construed that the present disclosure is limited to these particular embodiments. It should be understood that various embodiments disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the methods or processes). In addition, while certain features of embodiments hereof are described as being performed by a single component, module, or unit for purposes of clarity, it should be understood that the features and functions described herein may be performed by any combination of components, units, or modules. Thus, various changes and modifications may be affected by one skilled in the art without departing from the spirit or scope of the invention as defined in the appended claims.

Further embodiments include:

Embodiment 1 is a computing system comprising: a control system configured to communicate with a robot having a robot arm that includes or is attached to an end effector apparatus, and to communicate with a camera; at least one processing circuit configured, when the robot is in an object handling environment including a source of objects for transfer to a destination within the object handling environment is provided, to perform the following for transferring a target object from the source of objects to the destination: identifying the target object from among a plurality of objects in the source of objects; generating an arm approach trajectory for the robot arm to approach the plurality of objects; generating an end effector apparatus approach trajectory for the end effector apparatus to approach the target object; generating a grasp operation for grasping the target object with the end effector apparatus; outputting an arm approach command to control the robot arm according to the arm approach trajectory to approach the plurality of objects; outputting an end effector apparatus approach command to control the robot arm in the end effector apparatus approach trajectory to approach the target object; and outputting an end effector apparatus control command to control the end effector apparatus in the grasp operation to grasp the target object.

Embodiment 2 is the computer system of embodiment 1, further including: generating a destination trajectory for the robot arm to approach the destination; outputting a robot arm control command to control the robot arm according to the destination trajectory; and outputting an end effector apparatus release command to control the end effector apparatus to release the target object at the destination.

Embodiment 3 is the computer system of embodiment 2, wherein determining the destination trajectory of the robot arm is based on an optimized destination trajectory time for the robot arm to travel from the source to the destination.

Embodiment 4 is the computer system of embodiment 2, wherein determining the destination trajectory of the robot arm is based on a projected grip stability between the end effector apparatus and the target object.

Embodiment 5 is the computer system of embodiment 1, wherein determining the end effector apparatus approach trajectory is based on an optimized end effector apparatus approach time for the end effector apparatus in the grasp operation to grasp the target object.

Embodiment 6 is the computer system of embodiment 5 wherein the optimized end effector apparatus approach time is determined based on an available grasping model for the target object.

Embodiment 7 is the computer system of embodiment 1 wherein determining the grasp operation includes determining at least one grasping model from a plurality of available grasping models for use by the end effector apparatus in the grasp operation.

Embodiment 8 is the computer system of embodiment 7 wherein the at least one processing circuit is further configured to determine a rank to each of the plurality of available grasping models according to a projected grip stability of each of the plurality of grasping models.

Embodiment 9 is the computer system of embodiment 8 wherein determining the at least one grasping model for use by the end effector apparatus is based on the rank with a highest determined value of the projected grip stability.

Embodiment 10 is the computer system of embodiment 1, wherein the at least one processing circuit is further configured for: generating one or more detection results, each representing a detected object of the one or more objects in the source of objects and including a corresponding object representation defining at least one of: an object orientation the detected object, a location the detected object in the source of objects, a location detected object with respect to other objects, and a degree of confidence determination.

Embodiment 11 is the computer system of embodiment 1, wherein the plurality of objects are substantially the same in terms of size, shape, weight, and material composition.

Embodiment 12 is the computer system of embodiment 1, wherein the plurality of objects vary from each other in size, shape, weight, and material composition.

Embodiment 13 is the computer system of embodiment 10, wherein identifying the target object from the one or more detection results includes: determining whether available grasping models exist for the detected objects; and pruning the detected objects without available grasping models from the detected objects.

Embodiment 14 is the computer system of embodiment 13, further comprising pruning the detected objects based on at least one of the object orientation, locations of the detected object in the source of objects, and/or inter-object distance.

Embodiment 15 is the computer system of embodiment 1, wherein the at least one processing circuit is further configured for identifying a plurality of target objects, including the target object, from a detection result.

Embodiment 16 is the computer system of embodiment 15, wherein the target object is a first target object of the plurality of target objects is associated with a first grasping model, and a second target object of the plurality of target objects is associated with a second grasping model.

Embodiment 17 is the computer system of embodiment 15, wherein identifying the plurality of target objects includes selecting the first target object for grasping by the end effector apparatus and the second target object for grasping by the end effector apparatus.

Embodiment 18 is the computer system of embodiment 17, wherein the at least one processing circuit is further configured for: outputting a second end effector apparatus approach command to control the robot arm to approach the second target object; outputting a second end effector apparatus control command to control the end effector apparatus to grasp the second target object generating a destination trajectory for the robot arm to approach the destination; outputting a robot arm control command to control the robot arm according to the destination trajectory; and outputting an end effector apparatus release command to control the end effector apparatus to release the first target object and the second target object at the destination.

Embodiment 19 is a method of picking a target object from a source of objects, comprising: identifying the target object in a plurality of objects in the source of objects; generating an arm approach trajectory for a robot arm having an end effector apparatus to approach the plurality of objects; generating an end effector apparatus approach trajectory for the end effector apparatus to approach the target object; generating a grasp operation for grasping the target object with the end effector apparatus; outputting an arm approach command to control the robot arm according to the arm approach trajectory to approach the plurality of objects; outputting an end effector apparatus approach command to control the robot arm in the end effector apparatus approach trajectory to approach the target object; and outputting an end effector apparatus control command to control the end effector apparatus in the grasp operation to grasp the target object.

Embodiment 20 is a non-transitory computer readable medium, configured with executable instructions for implementing a method for picking a target object from a source of objects, operable by at least one processing circuit via a communication interface configured to communicate with a robotic system, the method comprising: identifying the target object from among a plurality of objects in the source of objects; generating an arm approach trajectory for a robot arm having an end effector apparatus to approach the plurality of objects; generating an end effector apparatus approach trajectory for the end effector apparatus to approach the target object; generating a grasp operation for grasping the target object with the end effector apparatus; outputting an arm approach command to control the end effector apparatus in the arm approach trajectory approaching the plurality of objects; outputting an end effector apparatus approach command to control the robot arm in the end effector apparatus approach trajectory approaching the target object; and outputting an end effector apparatus control command to control the end effector apparatus in the grasp operation to grasp the target object.

1. A computing system comprising:
a control system configured to communicate with a robot having a robot arm that includes or is attached to an end effector apparatus, and to communicate with a camera;
at least one processing circuit configured, when the robot is in an object handling environment including a source of objects for transfer to a destination within the object handling environment is provided, to perform the following for transferring a target object from the source of objects to the destination:
identifying the target object from among a plurality of objects in the source of objects;
generating an arm approach trajectory for the robot arm to approach the plurality of objects;
generating an end effector apparatus approach trajectory for the end effector apparatus to approach the target object;
generating a grasp operation for grasping the target object with the end effector apparatus;
outputting an arm approach command to control the robot arm according to the arm approach trajectory to approach the plurality of objects;
outputting an end effector apparatus approach command to control the robot arm in the end effector apparatus approach trajectory to approach the target object; and
outputting an end effector apparatus control command to control the end effector apparatus in the grasp operation to grasp the target object.

2. The computing system of claim 1, further including:
generating a destination trajectory for the robot arm to approach the destination;
outputting a robot arm control command to control the robot arm according to the destination trajectory; and
outputting an end effector apparatus release command to control the end effector apparatus to release the target object at the destination.

3. The computer system of claim 2 wherein determining the destination trajectory of the robot arm is based on an optimized destination trajectory time for the robot arm to travel from the source to the destination.

4. The computer system of claim 2 wherein determining the destination trajectory of the robot arm is based on a projected grip stability between the end effector apparatus and the target object.

5. The computer system of claim 1 wherein determining the end effector apparatus approach trajectory is based on an optimized end effector apparatus approach time for the end effector apparatus in the grasp operation to grasp the target object.

6. The computer system of claim 5 wherein the optimized end effector apparatus approach time is determined based on an available grasping model for the target object.

7. The computer system of claim 1 wherein determining the grasp operation includes determining at least one grasping model from a plurality of available grasping models for use by the end effector apparatus in the grasp operation.

8. The computer system of claim 7 wherein the at least one processing circuit is further configured to determine a rank to each of the plurality of available grasping models according to a projected grip stability of each of the plurality of grasping models.

9. The computer system of claim 8 wherein determining the at least one grasping model for use by the end effector apparatus is based on the rank with a highest determined value of the projected grip stability.

10. The computer system of claim 1, wherein the at least one processing circuit is further configured for:
generating one or more detection results, each representing a detected object of the one or more objects in the source of objects and including a corresponding object representation defining at least one of: an object orientation the detected object, a location the detected object in the source of objects, a location detected object with respect to other objects, and a degree of confidence determination.

11. The computer system of claim 1, wherein the plurality of objects are substantially the same in terms of size, shape, weight, and material composition.

12. The computer system of claim 1, wherein the plurality of objects vary from each other in size, shape, weight, and material composition.

13. The computer system of claim 10, wherein identifying the target object from the one or more detection results includes:
determining whether available grasping models exist for the detected objects; and
pruning the detected objects without available grasping models from the detected objects.

14. The computer system of claim 13 further comprising pruning the detected objects based on at least one of the object orientation, locations of the detected object in the source of objects, and/or inter-object distance.

15. The computer system of claim 1, wherein the at least one processing circuit is further configured for identifying a plurality of target objects, including the target object, from a detection result.

16. The computer system of claim 15, wherein the target object is a first target object of the plurality of target objects associated with a first grasping model, and a second target object of the plurality of target objects is associated with a second grasping model.

17. The computer system of claim 15, wherein identifying the plurality of target objects includes selecting the first target object for grasping by the end effector apparatus and the second target object for grasping by the end effector apparatus.

18. The computer system of claim 17, wherein the at least one processing circuit is further configured for:
outputting a second end effector apparatus approach command to control the robot arm to approach the second target object;
outputting a second end effector apparatus control command to control the end effector apparatus to grasp the second target object generating a destination trajectory for the robot arm to approach the destination;
outputting a robot arm control command to control the robot arm according to the destination trajectory; and
outputting an end effector apparatus release command to control the end effector apparatus to release the first target object and the second target object at the destination.

19. A method of picking a target object from a source of objects, comprising:
identifying the target object in a plurality of objects in the source of objects;
generating an arm approach trajectory for a robot arm having an end effector apparatus to approach the plurality of objects;
generating an end effector apparatus approach trajectory for the end effector apparatus to approach the target object;
generating a grasp operation for grasping the target object with the end effector apparatus;
outputting an arm approach command to control the robot arm according to the arm approach trajectory to approach the plurality of objects;
outputting an end effector apparatus approach command to control the robot arm in the end effector apparatus approach trajectory to approach the target object; and
outputting an end effector apparatus control command to control the end effector apparatus in the grasp operation to grasp the target object.

20. A non-transitory computer readable medium, configured with executable instructions for implementing a method for picking a target object from a source of objects, operable by at least one processing circuit via a communication interface configured to communicate with a robotic system, the method comprising:
identifying the target object from among a plurality of objects in the source of objects;
generating an arm approach trajectory for a robot arm having an end effector apparatus to approach the plurality of objects;
generating an end effector apparatus approach trajectory for the end effector apparatus to approach the target object;
generating a grasp operation for grasping the target object with the end effector apparatus;
outputting an arm approach command to control the robot arm according to the arm approach trajectory approaching the plurality of objects;
outputting an end effector apparatus approach command to control the robot arm in the end effector apparatus approach trajectory approaching the target object; and
outputting an end effector apparatus control command to control the end effector apparatus in the grasp operation to grasp the target object.
